(19) United States
(12) Patent Application Publication
(10) Pub. No.: US 2014/0052770 A1
(43) Pub. Date: Feb. 20, 2014

(54) SYSTEM AND METHOD FOR MANAGING MEDIA CONTENT USING A DYNAMIC PLAYLIST

(71) Applicants: Christian Gran, Falkensee (DE); Ralph Neff, San Diego, CA (US); Magdalena Leuen Espelien, Mercer Island, WA (US)

(72) Inventors: Christian Gran, Falkensee (DE); Ralph Neff, San Diego, CA (US); Magdalena Leuen Espelien, Mercer Island, WA (US)

(73) Assignee: PACKETVIDEO CORPORATION

(21) Appl. No.: 13/585,454

(22) Filed: Aug. 14, 2012

(51) Int. Cl. G06F 15/16

(52) U.S. Cl. 709/203

(57) ABSTRACT

A system and a method for managing media content using a dynamic playlist are provided. The system has a media server which offers a dynamic queue of media objects to be played by a media playback device using a playlist of generic URLs. The content of the dynamic queue may be modified or adapted by the media server after the playlist is delivered to the media playback device or while the media playback device is simultaneously playing media objects from the queue using the playlist. The system and method provide that the media server may adapt the list of media objects referenced by a playlist after the playlist is delivered, despite the media server not having access to edit the delivered playlist. The media server may provide a dynamic media service to any media playback device which supports one or more standard, well-known playlist formats.

### BACKGROUND OF THE INVENTION

The present invention generally relates to a system and a method for managing media content using a dynamic playlist. More specifically, the system has a media server which offers a dynamic queue of media objects to be played by a media playback device using a playlist of generic URLs. The content of the dynamic queue may be modified by the media server after the playlist is delivered to the media playback device. Moreover, the content of the dynamic queue may be modified while the media playback device is simultaneously playing media objects from the queue using the playlist. The system and method provide that the media server may adapt the list of media objects referenced by a playlist after the playlist is delivered, despite the media server not having access to edit the delivered playlist. Further, the system and method provide that the media server may adapt the list of media objects referenced by a playlist even while the playlist is being used by a media playback device to play back the referenced media. The media server may provide a dynamic media service to any media playback device which supports one or more standard, well-known playlist formats.

Digital media has revolutionized the entertainment industry. Today's media consumer is able to watch video content, listen to music and other audio content, and view photographs using a wide range of media playback devices, including portable media players, cellular telephones, personal digital assistants, tablet computing devices, networked televisions, networked stereos, networked digital photo frames, personal computers, laptop computers, gaming devices, and the like. Such devices may be used to access and play media content stored on the media playback device, media content available in a local network connected to the media playback device, and/or media content available to the media playback device via a wide area network such as the internet.

A media server may organize media content to make such content available to media playback devices over a network. The media server may reside in the same local area network as the playback device, or the media server may be remotely accessible via the internet. The media server may present organized lists of available media content to the media playback devices, and the media playback devices may use these lists to browse and select media content for retrieval and playback. The organized lists may be presented as an organized hierarchy of files and/or folders, as a series of web pages with links to media objects, as search results generated in response to a user-directed search, and/or the like. The organized lists necessarily include metadata which describes the available media objects. The media playback device may present the organized lists including the metadata to a user, and the user may select media objects for playback. As a result, the media playback device may send requests to the media server in order to retrieve and play back the selected media content.

The interaction between the media playback device and the media server may be based on proprietary protocols specific to a media service. For example, Netflix offers a video streaming service based on proprietary protocols, and Spotify offers a music streaming service based on proprietary protocols. In such cases, the media playback device must be equipped with a proprietary media client designed to work with the media service. Alternately, the interaction between the media playback device and the media server may be based on well-known standard protocols which may be supported by standard software available on many media playback devices. For example, the media server may present organized lists of media content using web pages viewable with standard web browsers, and may further deliver the media content using well-known compression methods in standard file formats and/or streaming formats. As a second example, the media server may support media home networking protocols such as Universal Plug and Play Audio Video (UPnP AV) and/or Digital Living Network Alliance (DLNA). Such a media server may interwork with any media playback devices and/or control point devices which are compliant to the UPnP AV standards and/or the DLNA guidelines.

A playlist is a well-known structure for organizing and/or presenting media content for playback. FIG. 1 illustrates a typical prior art playlist. The playlist contains multiple entries which reference available media objects. The media objects may be, for example, video streams, video files, video clips, movies, television show episodes, audio streams, audio files, digital music tracks, digital audio books, digital photographs, and/or the like. For each media object referenced by the playlist, the playlist may contain metadata which describes the media object, and a location field which specifies the location of the media object. The metadata may include one or multiple of a song title, a movie title, a TV show title, an artist name, an album title, a composer, a track number, an episode number, a publisher, a date, a description, and/or the like.

The location field may specify the location of the media object within a local file system of the media playback device, or the location field may specify a network location from which the media object may be retrieved. The location fields provide references to the various media objects, as these objects are not stored within the playlist itself. Several playlist formats are well-specified and are widely supported by media playback devices. Examples of well-specified playlist formats are M3U, XSPF, ASX, and WPL. A media playback device may thus parse and interpret a playlist file, may present the metadata of the referenced media objects to a user, and may allow the user to play back the referenced media objects. A typical media playback device will allow the user to select media objects for individual playback, will allow the user to play the media objects sequentially in the listed order, will allow the user to navigate the playlist by skipping forward to the next media object and/or backward to the previous media object, and/or the like.

There are other well-known structures which may deliver metadata and location information for a list of available media objects, and which may be used by a media playback device to retrieve and play back the referenced media objects. For example, the UPnP AV Content Directory specifications define a container object (sometimes referred to as a “Content Directory Service Object”) which may specify metadata and location information for one or multiple media objects. A UPnP AV control point and/or a UPnP AV renderer may receive the container object when browsing or searching a UPnP AV server, and may use the container object to retrieve and play the referenced media objects. A UPnP AV container object is therefore a playlist for our purposes. More generally, a playlist is any data structure which provides location information and optionally metadata for a list of media objects, and which enables a media playback device to retrieve and play the referenced media objects using the location information.

A media server may provide playlists as described further below. Such playlists may be created by a user to organize media content for playback. For example, a software media player or an online media service may allow a user to create a playlist which references media content chosen by the user. Alternately, the playlists may be created by the server or by a media service associated with the server in order to provide access to media content available from the server. For example, the media server may create a playlist of popular media objects, featured media objects, recently played media objects, media objects of a certain genre, media objects created by a certain artist, and/or the like. In either case, the entries of the playlist typically refer to specific media objects available from the media server and/or from an associated media service.

The media server may advertise a playlist in a well-known playlist format, and may provide the playlist to a media playback device. The media playback device may then parse and use the playlist to request and/or retrieve the referenced media content from the media server for playback.

Existing traditional playlists and their operation have a number of problems and limitations. For example, one such problem occurs when a playlist changes. Typically, the user of a traditional playlist is not able to fully utilize and realize the advantages of changes to the playlist which may limit the user's access to new content.

For example, such a limitation occurs in the following situation. When a media server delivers a playlist to a media playback device, the media playback device usually stores a local copy of the playlist and then uses the local copy to play back the referenced media objects. However, the media server has no access to the local copy of the playlist on the media playback device, and so the media server is unable to modify the playlist after the delivery. Thus, a traditional playlist is not suitable for providing a dynamic media service, in which the list of media objects conveyed by the playlist would adapt or change over time.

A system and method by which the media server may adapt the list of media objects referenced by a playlist after the playlist is delivered, despite the media server not having access to edit the delivered playlist would be advantageous.

Furthermore, a system and method by which the media server may adapt the list of media objects referenced by a playlist even while the playlist is being used by a media playback device to play back the referenced media would be advantageous. The media server may provide a dynamic media service to any media playback device which supports one or more standard, well-known playlist formats.

Another problem and limitation with existing traditional playlists and their operation relates to the media playback devices and their associated limitations and problems. For various reasons, including size, cost and/or complexity, some media playback devices have limited user interfaces which are not optimal for browsing media, conducting user-directed searches, or for organizing media content for playback. For example, a networked stereo device may have a very small display, may have no pointer capability (i.e. no mouse, touchscreen, or other pointing device), and may have no convenient way to enter text. As another example, a networked television may be directly controlled by a push-button infrared remote control, and so the networked television may have no pointer capability and may have no convenient way to enter text. Allowing external control of such devices by other devices which have more advanced user interface capabilities would be advantageous.

For example, a user might wish to browse and select media objects using a touchscreen-equipped tablet computing device such as an iPad, and then display the selected media objects on a networked television with a large high definition screen. This use case is supported by UPnP AV and DLNA protocols through the concept of an external control point which sends commands directly to the renderer. However, many DLNA compliant renderers do not support external control. On such devices, the user is limited to browse and select media content from a media server using the internal control point built into the renderer, which must then be controlled using the limited user interface conventions of the renderer (e.g. a push-button infra-red remote control of a networked television, as noted earlier).

Therefore, a system and method for controlling the playback of media objects on a media playback device using a separate control device wherein the separate control device does not send command messages to the media playback device would be advantageous. More specifically, a system and method for using a separate control device to dynamically select media objects and to cause the selected media objects to be played on a media playback device which cannot receive command messages from the control device and/or which does not support an external control protocol would be advantageous.

Further problems and limitations with existing traditional playlists and their operation relate to streaming media and its associated limitations and problems. Internet Radio protocols such as Shoutcast may deliver multiple music tracks as a continuous stream of digital music data with periodically interleaved metadata. The metadata provides updated information about each music track. For example, the metadata may convey a song title, an album name, an artist name, a genre, and/or the like. A Shoutcast stream is designed to work with media playback devices which are aware of the Shoutcast protocols, and such devices are capable of extracting the metadata from the stream in order to display information about the music tracks as the tracks are playing continuously on the media playback device.

Standard media servers such as a UPnP AV MediaServer and/or a DLNA media server often provide access to internet radio streams and so are capable of delivering such streams to media playback devices which may not support internet radio protocols such as Shoutcast. The typical solution is to reformat the continuous stream of music data and deliver the stream as a single file of a file format which the media playback device supports. The single file delivered to the media playback device is of semi-infinite length, and delivery of this file is broken off only when the media playback device disconnects from the delivery session. The media playback device may play the music data from the internet radio stream; however, the media playback device is not able to receive the per-track metadata updates. Standard audio file formats such as MP3 are designed to carry a single music track with a single set of metadata tags per file. For this reason, a standard media playback device may not display the per-track metadata for an internet radio station when such a station is reformatted by a media server.

A system and method for reformatting an internet radio stream for delivery to a media playback device in such a way that the interleaved metadata from the internet radio stream is delivered in a form which is understandable to and displayable by the media playback device would be advantageous.

### SUMMARY OF THE INVENTION

The present invention generally relates to a system and a method for utilizing a dynamic queue provided by a media server to access media objects for playback by a media playback device. More specifically, a media server may dynamically map generic URLs from a playlist of generic URLs to a set of available media objects. A media playback device may parse the playlist to extract the generic URLs, and may use a generic URL to request media content from the media server. The media server may map and/or may bind the generic URL of the received request to an available media object, and may deliver the media object to the media playback device in response to the request. The media server may modify the mapping of generic URLs to media objects, and may utilize the modified mapping to respond to subsequent requests from the media playback device.

In an embodiment of the present invention, a system for managing and delivering media in a network is provided. The system has a media server and a media playback device connected to the network and a plurality of media objects wherein the media server has access to the plurality of media objects. The system has a playlist having a plurality of generic URLs wherein each of the plurality of generic URLs does not refer to a specific media object and wherein each of the plurality of generic URLs specifies a position within the playlist wherein the media playback device transmits a first media request specifying a first generic URL from the playlist of generic URLs to the media server. The system also has a dynamic queue having a plurality of entries. The dynamic queue has a current state that is stored by the media server. The media server maps the first media request to the first entry of the plurality of entries in the dynamic queue, and the media server determines a first media object to deliver to the media playback device in response to the first media request. The first media object corresponds to the first entry in the dynamic queue mapped by the media server in response to the first media request. The media server delivers the first media object to the media playback device via the network.

In an embodiment of the present invention, an external control device is used to select media objects and/or to control playback of selected media objects on a media playback device which does not support control by the external control device, and/or which is incapable of receiving control commands from the external control device.

In an embodiment, the system has a control device connected to the network wherein the control device controls the current state of the dynamic queue and wherein the control device is a different device than the media server.

In an embodiment, the playlist has a format selected from the group consisting of: M3U, XSPF, ASX and WPL.

In an embodiment, the media playback device renders the first media object for a user and the media server modifies the dynamic queue while the media playback device is rendering the first media object.

In an embodiment, the playlist is a UPnP AV container object.

In an embodiment, the media playback device renders the first media object for a user wherein the media server modifies the dynamic queue while the media playback device is rendering the first media object.

In an embodiment, a method for providing media objects from a media server to a media playback device wherein the media server is connected to a network and wherein the media playback device is connected to the network is provided. The method has the steps of: providing a plurality of media objects wherein the media server has access to the plurality of media objects; providing a playlist having a plurality of generic URLs wherein each of the plurality of generic URLs does not refer to a specific media object and wherein each of the plurality of generic URLs specifies a position within the playlist; transmitting a first media request specifying a first generic URL of the plurality of generic URLs to the media server wherein the media playback device transmits the first media request to the media server; providing a dynamic queue having a plurality of entries wherein the dynamic queue has a current state and wherein the current state of the dynamic queue is stored by the media server; mapping the first media request to a first entry of the plurality of entries in the dynamic queue wherein the media server maps the first media request to the first entry in the dynamic queue; determining a first media object to deliver to the media playback device in response to the first media request wherein the first media object corresponds to the first entry in the dynamic queue mapped by the media server in response to the first media request; and delivering the first media object to the media playback device wherein the media server delivers the first media object to the media playback device via the network.

In an embodiment, a method for providing media objects from a media server to a media playback device is provided. The method has the step of modifying the dynamic queue while simultaneously delivering the first media object from the dynamic queue to the media playback device wherein the media server modifies the dynamic queue.

In an embodiment, a method for providing media objects from a media server to a media playback device is provided. The method has the step of modifying the dynamic queue by adding a media object to the dynamic queue while simultaneously delivering a media object from the dynamic queue to the media playback device wherein the media server adds the media object to the dynamic queue.

In an embodiment, a method for providing media objects from a media server to a media playback device is provided. The method has the step of modifying the dynamic queue by deleting a media object from the dynamic queue while simultaneously delivering a media object from the dynamic queue to the media playback device wherein the media server deletes the media object from the dynamic queue.

In an embodiment, a method for providing media objects from a media server to a media playback device is provided. The method has the step of modifying the dynamic queue by re-ordering the media objects within the dynamic queue while simultaneously delivering a media object from the dynamic queue to the media playback device wherein the media server re-orders the media objects within the dynamic queue.

In an embodiment, a method for providing media objects from a media server to a media playback device is provided. The method has the step of modifying the dynamic queue while simultaneously delivering the first media object from the dynamic queue to the media playback device wherein the media server modifies the dynamic queue based upon a list of media objects available from a remote website.

In an embodiment, a method for providing media objects from a media server to a media playback device is provided. The method has the steps of: transmitting a second media request from the playlist of generic URLs to the media server wherein the media playback device transmits the media request to the media server; and modifying the dynamic queue in response to the receipt of the media request, wherein the media server modifies the dynamic queue and wherein the timing of the second media request indicates that the previously delivered first media object was skipped by the media playback device.

In an embodiment, a method for providing media objects from a media server to a media playback device is provided. The method has the steps of: transmitting a second media request from the playlist of generic URLs to the media server wherein the media playback device transmits the second media request to the media server; and modifying the dynamic queue in response to the receipt of the second media request, wherein the media server modifies the dynamic queue and wherein the timing of the second media request indicates that the previously delivered first media object was not completely played by the media playback device.

In an embodiment, a method for providing media objects from a media server to a media playback device is provided. The playlist has a list of n generic URLs used to request, retrieve and play media objects from a queue of m media objects, where n and m are integers and where n is not equal to m.

In an embodiment, a method for providing media objects from a media server to a media playback device is provided wherein the integer n is equal to 2.

In an embodiment, a method for providing media objects from a media server to a media playback device is provided wherein the integer n is less than the integer m.

In an embodiment, a method for providing media objects from a media server to a media playback device is provided wherein the integer n is at least 3 and wherein the media server delivers media objects from the dynamic queue to the media playback device. The method has the step of determining forward movement through the dynamic queue by comparing the position of a generic URL from one media request to the position of a generic URL from a subsequent media request and determining that the position has incremented between the two media requests wherein the media server compares the positions and determines that the subsequent position has incremented.

In an embodiment, a method for providing media objects from a media server to a media playback device wherein the integer n is at least 3 and wherein the media server delivers media objects from the dynamic queue to the media playback device is provided. The method has the step of determining forward movement through the dynamic queue by detecting that the media playback device transmitting media requests looped from a last generic URL of the playlist back to the first generic URL of the playlist wherein the media server determines the movement.

In an embodiment, a method for providing media from a media server to a media playback device in a network is provided. The method has the steps of: providing a plurality of media objects wherein the media server has access to the plurality of media objects; providing a playlist having a plurality of generic URLs wherein each of the plurality of generic URLs does not refer to a specific media object and wherein each of the plurality of generic URLs has a position within the playlist; transmitting a media request specifying a generic URL from the playlist of generic URLs to the media server wherein the media playback device transmits the media request to the media server; determining the media object to deliver in response to the media request by mapping the generic URL specified in the media request to an entry in a dynamic queue stored in the media server wherein the media server maps the generic URL to the entry in the dynamic queue wherein the dynamic queue has a current state and wherein the current state of the dynamic queue is stored by the media server; controlling the current state of the dynamic queue using a control device, wherein the control device is a different device than the media server; and delivering the media object to the media playback device wherein the media server delivers the media object to the media playback device via the network.

In an embodiment, a method for providing media from a media server to a media playback device in a network is provided. The method has the step of using the control device to cause the media server to modify the dynamic queue while the media server is simultaneously delivering the media object from the dynamic queue to the media playback device.

In an embodiment, a method for providing media from a media server to a media playback device in a network is provided. The method has the step of using the control device to cause the media server to modify the dynamic queue by adding a media object to the dynamic queue while simultaneously delivering the media object from the dynamic queue to the media playback device.

In an embodiment, a method for providing media from a media server to a media playback device in a network is provided. The method has the step of using the control device to cause the media server to modify the dynamic queue by deleting a media object from the dynamic queue while simultaneously delivering the media object from the dynamic queue to the media playback device.

In an embodiment, a method for providing media from a media server to a media playback device in a network is provided. The method has the step of using the control device to cause the media server to modify the dynamic queue by re-ordering the media objects within the dynamic queue while simultaneously delivering the media object from the dynamic queue to the media playback device.

In an embodiment, a method for providing media from a media server to a media playback device in a network is provided. The method has the step of delivering a default media object from the media server to the media playback device if the current state of the dynamic queue is empty when the media request is received by the media server.

In an embodiment, a method for providing media from a media server to a media playback device in a network wherein the default media object is a video object containing blank visual content and silent audio is provided.

In an embodiment, a method for providing media from a media server to a media playback device in a network wherein the default media object is an audio object containing silent audio is provided.

In an embodiment, a method for providing media from a media server to a media playback device in a network wherein the default media object is a company logo is displayed.

In an embodiment, a method for providing media from a media server to a media playback device in a network wherein the default media object is a video advertisement is provided.

In an embodiment, a method for providing media from a media server to a media playback device in a network wherein the default media object is an audio advertisement is provided.

In an embodiment, a method for providing media from a media server to a media playback device in a network wherein the default media object is a mix of blank/silent default media objects and ad-bearing default media objects is provided.

In an embodiment, a method for providing media from a media server to a media playback device in a network is provided. The method has the step of displaying a web page provided by the media server on the control device wherein a user of the control device controls the dynamic queue using the web page.

In an embodiment, a method for providing media from a media server to a media playback device in a network wherein the control device is an UPnP AV control point is provided.

In an embodiment, a method for providing media from a media server to a media playback device in a network is provided. The method has the steps of: providing the media server with a UPnP media renderer component; browsing the media server with the UPnP AV control point to discover media objects using UPnP AV protocols; and adding media objects to the dynamic queue by instructing the UPnP media renderer component of the media server to render media objects discovered using the UPnP AV protocols.

In an embodiment, a method for providing media from a media server to a media playback device in a network is provided. The method has the step of selecting media objects for addition to the dynamic queue wherein the control device selects the media objects while the media playback device is playing other media objects from the dynamic queue wherein the media playback device requests delivery of the selected media objects using a playlist of generic URLs and further wherein the media playback device does not support external control by the control device.

In an embodiment, a method for providing media from a media server to a media playback device in a network is provided. The method has the step of selecting media objects for addition to the dynamic queue wherein the control device selects the media objects while the media playback device is playing other media objects from the dynamic queue wherein the media playback device requests delivery of the selected media objects using a playlist of generic URLs and further wherein the media playback device is not capable of receiving a command from the control device which selects the media objects.

In an embodiment, a method for providing media from a media server to a media playback device in a network wherein the media playback device has a user interface having a first level of capability and the control device has a user interface having a second level of capability is provided. The first level of capability is less than the second level of capability.

In an embodiment, a method for providing media from a media server to a media playback device in a network wherein the media playback device is a networked stereo device with small screen and no text input capability and the control device is a touchscreen-equipped tablet computing device is provided.

In an embodiment, a method for providing media from a media server to a media playback device in a network wherein the media playback device is a networked television without a touchscreen and the control device is a touchscreen-equipped tablet computing device is provided.

In an embodiment, a method is provided for transforming a continuous stream of media into individual media objects using a media server, the method having the steps of: accessing a continuous stream of encoded media with interleaved metadata; transforming the continuous stream of encoded media with interleaved metadata into a plurality of individual media objects using the media server; providing a playlist having a plurality of generic URLs wherein each of the plurality of generic URLs does not refer to a specific media object and wherein each of the plurality of generic URLs has a position within the playlist; using the generic URLs to enable a media playback device to request, retrieve and play the individual media objects; delivering the individual media objects to the media playback device for playback; and displaying the metadata for each of the individual media objects on the media playback device.

In a further embodiment of the present invention, a media server transforms an incoming internet radio stream into distinct audio objects. The media server delivers the distinct audio objects to a media playback device in response to media requests from the media playback device. The media requests are based on generic URLs from a playlist of generic URLs. The media server extracts metadata from the incoming internet radio stream, and embeds the corresponding metadata into the distinct audio object to which the metadata corresponds. The media playback device sends media requests to the media server, and the media server delivers the distinct audio objects to the media playback device in response to the media requests. The media playback device receives each audio object, plays the audio content of each audio object and simultaneously displays the metadata which corresponds to each audio object.

In an embodiment, a method is provided for transforming a continuous stream of media into individual media objects using a media server further having the steps of: transmitting a first media request which specifies a first generic URL in the playlist of the plurality of generic URLs; extracting the individual media objects from the continuous media stream, wherein the media server extracts the individual media objects in response to receiving the first media request which specifies the first generic URL in the playlist of the plurality of generic URLs; and buffering the individual media objects from the continuous media stream, wherein the media server buffers the individual media objects in response to receiving the first media request which specifies the first generic URL in the playlist of the plurality of generic URLs.

In an embodiment, a method is provided for transforming a continuous stream of media into individual media objects using a media server further having the steps of: detecting differences in the metadata in the continuous stream of encoded media, and determining transition points between media objects in the continuous stream of encoded media wherein the media server determines the transition points based on the detected differences in the metadata.

In an embodiment, a method is provided for transforming a continuous stream of media into individual media objects using a media server further having the steps of: detecting differences in the audio properties of the continuous stream of encoded media, and determining transition points between media objects in the continuous stream of encoded media wherein the media server determines the transition points based on the detected differences in the audio properties of the continuous media stream.

In an embodiment of the present invention, a system for delivering media in a network is provided. The system has a media server connected to the network; a playlist having a plurality of generic URLs generated by the media server wherein the media server generates each generic URL to encode a specification of a position of each generic URL within the playlist; and a media playback device capable of playing a playlist connected to the media server via the network wherein the media server delivers the playlist of generic URLs to the media playback device.

In an embodiment, the media server encodes an identifier into each generic URL and further wherein the media server maintains a record which maps the identifiers to the position of the generic URL within the playlist.

In an embodiment, the system has a first media request specifying a first generic URL of the plurality of generic URLs. The media playback device transmits the first media request to the media server, and the media server selects a media object for delivery to the media playback device in response to the first media request. The selection of the media object is a function of the time at which the first media request is received by the media server.

In an embodiment, a method is provided for using a playlist with a media server and a media playback device to manage media objects in a network wherein the media server and the media playback device are connected to the network, the method having the steps of: providing a playlist having a plurality of generic URLs wherein each of the plurality of generic URLs does not refer to a specific media object and wherein each of the plurality of generic URLs has a position within the playlist; transmitting a first media request specifying a first generic URL to the media server wherein the media playback device transmits the first media request; determining the position of the first generic URL in a playlist of generic URLs wherein the media server determines the position; and using the determined position to select a first media object for delivery to the media playback device in response to the first media request wherein the media server selects the media object for delivery.

In an embodiment, a method is provided for using a playlist with a media server and a media playback device to manage media objects in a network further having the steps of: transmitting a second media request specifying a second generic URL to the media server wherein the media playback device transmits the second media request subsequent to transmitting the first media request; and selecting a second media object for delivery to the media playback device based on a difference between the position of the second generic URL specified in the second media request and the position of the first generic URL specified in the first media request wherein the media server selects the media object for delivery.

In an embodiment, a method is provided for using a playlist with a media server and a media playback device to manage media objects in a network further having the steps of: transmitting a second media request specifying the first generic URL to the media server wherein the media playback device transmits the second media request subsequent to transmitting the first media request; and selecting a second media object for delivery to the media playback device wherein the media server selects the second media object for delivery and wherein the first media object and the second media object do not encode the same media content.

In an embodiment, a method is provided for using a playlist with a media server and a media playback device to manage media objects in a network further having the steps of: encoding an identifier into each generic URL wherein the media server encodes the identifier into each generic URL; and maintaining a record that maps the identifier to the position of the generic URL within the playlist and further wherein the media server maintains the record.

In an embodiment of the present invention, the system has a media server which offers a dynamic queue of media objects to be played by a media playback device using a playlist of generic URLs. The content of the dynamic queue may be modified by the media server after the playlist is delivered to the media playback device. Moreover, the content of the dynamic queue may be modified while the media playback device is simultaneously playing media objects from the queue using the playlist.

An advantage of the present invention is to provide a system and method by which the media server may adapt the list of media objects referenced by a playlist after the playlist is delivered, despite the media server not having access to edit the delivered playlist.

Another advantage of the present invention is to provide a system and method by which the media server may adapt the list of media objects referenced by a playlist even while the playlist is being used by a media playback device to play back the referenced media. The media server may provide a dynamic media service to any media playback device which supports one or more standard, well-known playlist formats.

A further advantage of the present invention is to provide a system and method for controlling the playback of media objects on a media playback device using a separate control device wherein the separate control device does not send command messages to the media playback device. More specifically, an advantage of the present invention is to provide a system and method for using a separate control device to dynamically select media objects and to cause the selected media objects to be played on a media playback device which cannot receive command messages from the control device and/or which does not support an external control protocol.

A further advantage of the present invention is to provide a method for reformatting and delivering an internet radio data stream.

Yet another advantage of the present invention is to provide a system and method for reformatting an internet radio stream for delivery to a media playback device in such a way that the interleaved metadata from the internet radio stream is delivered in a form which is understandable to and displayable by the media playback device.

A further advantage of the present invention is to provide a system and a method for using a dynamic playlist wherein the dynamic playlist is in a standard playlist format.

Additional features and advantages of the present invention are described in, and will be apparent from, the detailed description of the presently preferred embodiments and from the drawings.

### BRIEF DESCRIPTION OF THE DRAWINGS

FIG. 1 illustrates a prior art playlist which lists media objects and which specifies locations from which the media objects may be accessed and/or retrieved.

FIG. 2 illustrates a typical network configuration in an embodiment of the present invention.

FIG. 3 illustrates a media server which dynamically maps media objects to generic URLs from a playlist of generic URLs in an embodiment of the present invention.

FIG. 4 illustrates a flowchart of a method by which a media server dynamically binds media objects to generic URLs in response to media requests from a media playback device in an embodiment of the present invention.

FIGS. 5a-5e illustrate a block diagram of a system and a flowchart of a method for utilizing a dynamic queue provided by a media server to access media objects for playback by a media playback device in an embodiment of the present invention.

FIG. 6 illustrates a typical network configuration in an embodiment of the present invention.

FIGS. 7a-7f illustrate a block diagram of a system and a flowchart of a method for indirectly controlling a media playback device in an embodiment of the present invention.

FIG. 8 illustrates a block diagram of a system and a flowchart of a method for reformatting and delivering an internet radio data stream in an embodiment of the present invention.

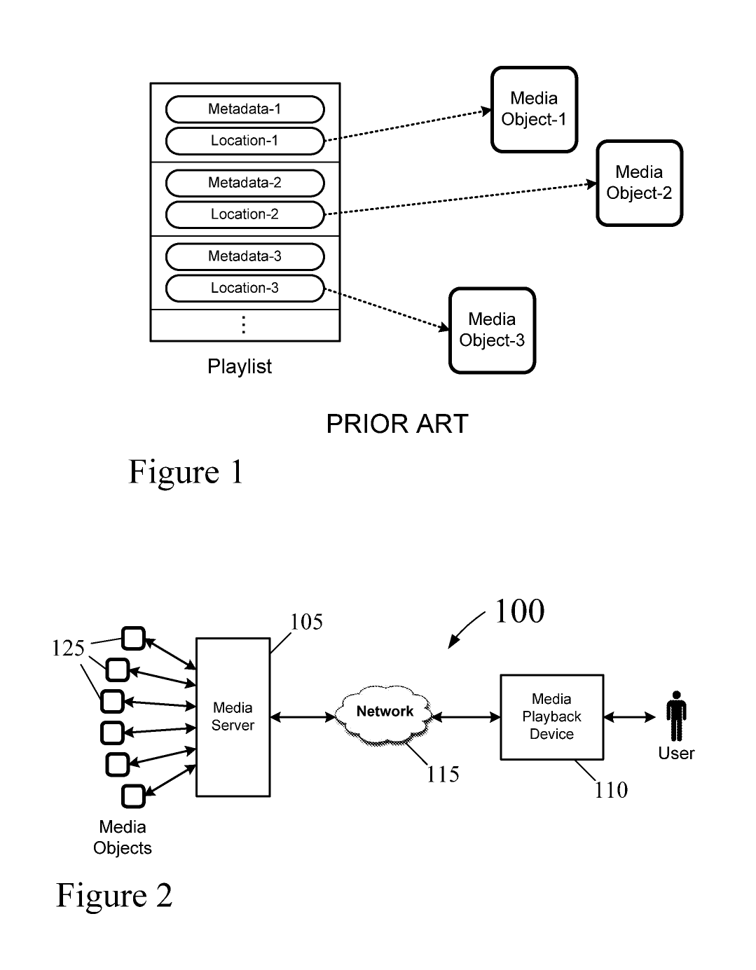

### DETAILED DESCRIPTION OF THE PREFERRED EMBODIMENTS

The present invention generally relates to a system and a method for managing media content using a dynamic playlist. More specifically, the system has a media server which offers a dynamic queue of media objects to be played by a media playback device using a playlist of generic URLs. The content of the dynamic queue may be modified by the media server after the playlist is delivered to the media playback device. Moreover, the content of the dynamic queue may be modified while the media playback device is simultaneously playing media objects from the queue using the playlist. The system and method provide that the media server may adapt the list of media objects referenced by a playlist after the playlist is delivered, despite the media server not having access to edit the delivered playlist. Further, the system and method provide that the media server may adapt the list of media objects referenced by a playlist even while the playlist is being used by a media playback device to play back the referenced media. The media server may provide a dynamic media service to any media playback device which supports one or more standard, well-known playlist formats.

A media server may dynamically map generic URLs from a playlist of generic URLs to a set of available media objects. A media playback device may parse the playlist to extract the generic URLs, and may use a generic URL to request media content from the media server. The media server may map and/or may bind the generic URL of the received request to an available media object, and may deliver the media object to the media playback device in response to the request. The media server may modify the mapping of generic URLs to media objects, and may utilize the modified mapping to respond to subsequent requests from the media playback device.

In an embodiment of the present invention, the system has a media server which offers a dynamic queue of media objects to be played by a media playback device using a playlist of generic URLs. The content of the dynamic queue may be modified by the media server after the playlist is delivered to the media playback device. Moreover, the content of the dynamic queue may be modified while the media playback device is simultaneously playing media objects from the queue using the playlist. Thus, the embodiment advantageously provides a system and method by which the media server may adapt the list of media objects referenced by a playlist after the playlist is delivered, despite the media server not having access to edit the delivered playlist. Further, the present invention provides a system and method by which the media server may adapt the list of media objects referenced by a playlist even while the playlist is being used by a media playback device to play back the referenced media. The media server may provide a dynamic media service to any media playback device which supports one or more standard, well-known playlist formats.

A media object may be an audio object, a visual object, or an audiovisual object. As used herein, an “audio object” is a digital media object which primarily conveys audio media. An MP3 file, an MP4 file containing a single media track of an audio type, and a Shoutcast (trademark of AOL Inc.) stream are examples of audio objects. An audio object may be a digital audio file, a digital audio stream, a music track, a song, an audio clip, a downloaded music object, and/or the like. As used herein, a “visual media object” refers to any media object which has a visual component, regardless of whether the media object has an audio component. A digital photograph, a photo slideshow, and an MP4 file containing an encoded TV show are examples of visual media objects. A visual media object may be a digital video file, a digital video stream, a music video, a fan video, a downloaded audiovisual media object, a video clip, a digital photograph, a collection of digital images, a collection of album cover images, a visual slideshow, a graphical animation, and/or the like. As used herein, an “audiovisual media object” is a digital media object which primarily conveys media having an audio component and a visual component. A Flash Video (FLV) file containing both audio and video, an MP4 file containing a first media track of an audio type and a second media track of a video type, and an RTSP session conveying an audio stream and a video stream are examples of audiovisual media objects.

A media object may be stored locally and/or remotely relative to a playlist which refers to the media object. For example, a playlist may reference a first digital audio file. The first digital audio file may be present on the same storage medium as the playlist, may be present in the same local network as the playlist, and/or may be accessible from the playlist location over the internet. The playlist may reference the first digital audio file using a local storage location, a remote network location, a URL and/or the like.

A media object may be stored in a database of media objects which may be any database known to one skilled in the art. For example, a media object database may be a library of digital music files; a collection of audio media objects on a digital storage medium, such as an electronic memory, a removable memory card, a hard drive or an optical disk; a collection of audio media objects on a media server device; a collection of audio media objects distributed among multiple storage devices in a local network; a collection of audio media objects available from a remote storage device via a network; a collection of audio media objects available from and/or accessible via a content service; and/or the like.

As used herein, “metadata” refers to information fields descriptive of an audio media object, a visual media object or an audiovisual media object. For example, the information fields may have one or more fields of a title, an artist, an author, a recording date, a music label, a publisher, a publication date, a copyright date, a genre, musical lyrics, a year, an album name, an album cover image, and/or the like.

Referring now to the drawings wherein like numerals refer to like parts, FIG. 2 illustrates a typical configuration of a system 100 in which the present invention may be utilized. As shown in FIG. 2, a media server 105 is connected to a media playback device 110 via a network 115. The network 115 may be a local area network such as a home network or an office network. The network 115 may be a wide area network such as a mobile phone carrier network or the Internet. The network 115 may span multiple networks which may include local area networks and/or wide area networks. The network 115 may utilize one or multiple network technologies such as Ethernet, WiFi, fiber optic communication, HomePlug, Multimedia over Coax (MoCA), and/or the like.

The media playback device 110 may be a portable media player, a cellular telephone, a smartphone, a personal digital assistant, a tablet computing device, a networked television, a networked stereo, a digital photo frame, a personal computer, a laptop computer, a gaming device, and/or the like. The media playback device 110 may be any device capable of requesting, receiving, and playing media content as known to one skilled in the art. Such capabilities may be provided by hardware, software, or some combination of hardware and software. The software may be intrinsic to the device and/or the device operating system, may be pre-loaded onto the device by a manufacturer or reseller of the device, may be installed onto the device by a user, and/or the like.

The media server 105 may be a local media server which resides in the same local network 115 as the media playback device 110. Alternately, the media server 105 may be connected to the media playback device 110 via a wide area network such as the internet. The media server 105 may support web protocols such as HTTP, HTML, JavaScript, ECMAscript, and/or the like. The media server 105 may support multimedia home networking protocols such as UPnP AV and/or DLNA. The media server 105 may support additional media delivery protocols such as the Real-Time Streaming Protocol (RTSP), HTTP Live Streaming, Smooth Streaming, MPEG-DASH, and/or the like. The media server 105 and the media playback device 110 may communicate via any web protocols, multimedia protocols, media delivery protocols, and/or other communication protocols as known to one skilled in the art. More specifically, the media playback device 110 may use any such protocols to request media objects from the media server 105.

The media server 105 may have access to media objects 125. The media objects 125 may be, for example, video streams, video files, video clips, movies, television show episodes, audio streams, audio files, digital music tracks, digital audio books, digital photographs, and/or the like. The media objects 125 may be stored locally on the media server 105, may reside on a storage device attached to the media server 105, may be accessible to the media server 105 via a network, and/or the like. The media server 105 may access the media objects 125 using any digital access mechanism known to one skilled in the art. While FIG. 2 illustrates a few representative media objects 125, the media server 105 may have access to any number of media objects 125. In practice, the media server 105 may have access to millions of media objects 125 and may provide access to these media objects 125 to the media playback device 110, or to multiple media playback devices simultaneously.

Also, while each FIG. depicts a single “media server”, one skilled in the art will recognize that media servers are often implemented using multiple connected server devices which may reside in multiple locations. Such a multiple-device implementation allows a media service to implement load balancing and failover techniques to improve service reliability. Therefore, the FIGs. should not be interpreted to limit the media server 105 to reside in a single device or to reside in a single location.

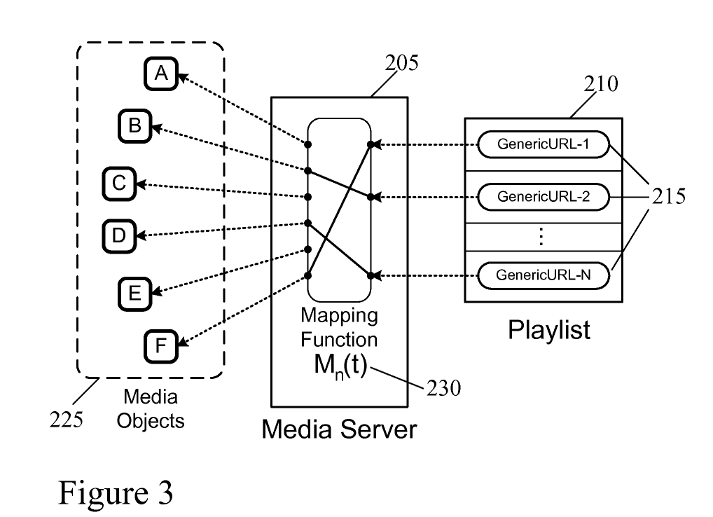

FIG. 3 illustrates a media server 205 and a playlist 210 of generic URLs 215 in an embodiment of the present invention. As used herein, “generic URL” means a URL which does not refer to a specific resource (e.g. to a specific media file). Instead, each generic URL 215 specifies a position within the playlist 210 of generic URLs 215. For example, “GenericURL-1” in the figure is shown to occupy the first position in the playlist 210, and “GenericURL-N” is shown to occupy the Nth position in the playlist 210. The playlist 210 will generally have at least two generic URLs 215 so that a media server may distinguish whether a media request refers to the same generic URL as used in a previous media request, or to a different generic URL. However, the playlist 210 may have three or more generic URLs 215 as will be evident from the examples which follow.

The media server 205 may determine the position given the specific generic URL 215. The media server 205 may map the generic URLs 215 to available media objects 225 as needed according to the internal logic of the media server 205 and/or according to external signals and events. Various examples of such internal logic and external signals and events are discussed in the disclosure below

The mapping of generic URLs to media files is depicted as Mapping Function Mₙ(t) 230 in FIG. 3. In an embodiment of the present invention, the media server 205 receives at time t an incoming request from the media playback device 110 (shown in the system 100 of FIG. 2) which specifies “generic URL n” where n denotes the position of the generic URL in a playlist of generic URLs. Mapping function Mₙ(t) 230 specifies the media object 225 which the media server 205 returns to the media playback device 110 in response to the request. In describing embodiments of the present invention, the mapping function Mₙ(t) 230 acts as a conceptual aid to describe the function of the media server 205 in the various embodiments. The mapping function Mₙ(t) 230 also shows that a given generic URL n may map to different media objects 225 at different times. Mapping function Mₙ(t) 230 will typically evolve with time as an internal state maintained by the media server 205. Moreover, the internal state of the media server 205 which describes Mₙ(t) 230 may be “incomplete” in a practical embodiment, meaning the media server 205 is not required to define nor to maintain internal states mapping media objects 225 to every generic URL 215 in the playlist 210 at any particular time t. At a minimum, the media server 205 must define Mₙ(t) 230 for a given generic URL n only in time to respond to an incoming media request which specifies generic URL n. In some embodiments, the media server 205 may maintain such states in advance of receiving the corresponding requests. However, in other embodiments the media server 205 may map a generic URL n to a specific media object in response to an incoming request based on that generic URL n. In the latter case, Mₙ(t) 230 may be defined piecemeal as the incoming requests are received and processed by the media server 205.

The generic URLs 215 must be recognizable to the media server 205, and the media server 205 must be capable of distinguishing the generic URLs 215 from one another when these URLs appear in incoming media requests received by the media server 205. Accordingly, the media server 205 may generate the playlist 210 to contain a set of generic URLs recognizable to the media server 205. The URLs may be arrayed in a pattern recognizable to the media server 205, or may contain unique IDs which the media server 205 records for later use in processing the incoming requests.

For example, the media server 205 may generate the playlist 210 to contain the following five generic URLs 215 which are arrayed in a pattern based on increasing generic URL index ‘n’:

http://www.myserver.com/generic-url-0001.mp3

http://www.myserver.com/generic-url-0002.mp3

http://www.myserver.com/generic-url-0003.mp3

http://www.myserver.com/generic-url-0004.mp3

http://www.myserver.com/generic-url-0005.mp3

As a second example, the media server 205 may generate the playlist 210 to contain the following three generic URLs 215 which each contain a unique index known to the media server 205:

http://172.16.4.7/c5fe892ce1af00

http://172.16.4.7/d49279b9385c7c

http://172.16.4.7/f80b6470a959f2

In either example, the media server 205 is able to extract the generic URL 215 from an incoming media request, and to determine the position the generic URL 215 occupies within the playlist 210 as the playlist 210 was generated by the media server 205 and/or delivered to the media playback device 110 which made the request.

In some embodiments, the media server 205 may present multiple playlists of generic URLs which may have different purposes. In this case, each generic URL 215 may additionally identify the playlist 210. For example, the media server 205 may have different playlists for ‘top five news videos’, ‘top five sports videos’, and ‘top five music videos’. In this case, the playlist 210 for ‘top five news videos’ may contain the following generic URLs:

http://192.68.0.105/top-5-news/item01.mp4

http://192.68.0.105/top-5-news/item02.mp4

http://192.68.0.105/top-5-news/item03.mp4

http://192.68.0.105/top-5-news/item04.mp4

http://192.68.0.105/top-5-news/item05.mp4

In some embodiments, the media server 205 may generate different playlists 210 of generic URLs 215 for delivery to different media playback devices 110. In this case, the generic URLs 215 may additionally identify the media playback device 110 for which the playlist 210 was generated and/or to which the playlist 210 was delivered. For example, a playlist generated for delivery to an Acme BV-704 networked television set may have the following generic URLs:

http://192.68.0.102/acme_bv-704/item01

http://192.68.0.102/acme_bv-704/item02

http://192.68.0.102/acme_bv-704/item03

http://192.68.0.102/acme_bv-704/item04

Identification of the playlist 210 and/or the media playback device 110 may be human-readable as in the above example; however, such human readability is not required. For example, the media server 205 could alternately create generic URLs 215 with randomly generated identification strings and simply maintain an internal record of which identification strings correspond to each playlist and/or each media playback device 110. The purpose is that the media server 205, when receiving an incoming media request, will be able to identify the playlist 210 and/or the media playback device 110 from which the media request was generated, as well as the position of the generic URL 215 within the playlist 210. Thus, the media server 205 may map an incoming media request generated from the ‘top-5-news’ playlist to a popular news video clip as opposed to a sports clip or a music clip. Also, the media server 205 may refer to an internal server state and/or mapping function which corresponds to the Acme BV-704 television when processing an incoming request from that specific media playback device 110. The media server 205 may maintain different states and/or mapping functions for each of multiple media playback devices, and may process the incoming media requests accordingly.

In some embodiments, the media server 205 may identify the media playback device 110 based on other information available in the incoming media requests. For example, the incoming media request may contain the IP Address of the media playback device 110, a session ID, a cookie, a user-agent field, or some other information by which the media server may identify the media playback device which generated and/or sent the media request. In such cases, the media server 205 may identify the media playback device 110 without relying on the information encoded in the generic URLs 215.

A playlist 210 of generic URLs 215 will generally contain at least two generic URLs; however, the playlist 210 may contain a higher number of generic URLs 215 without limit. The number of generic URLs 215 in the playlist 210 does not limit the number of media objects 225 which may be mapped to the generic URLs 215, as will be evident from the examples presented in the disclosure below.

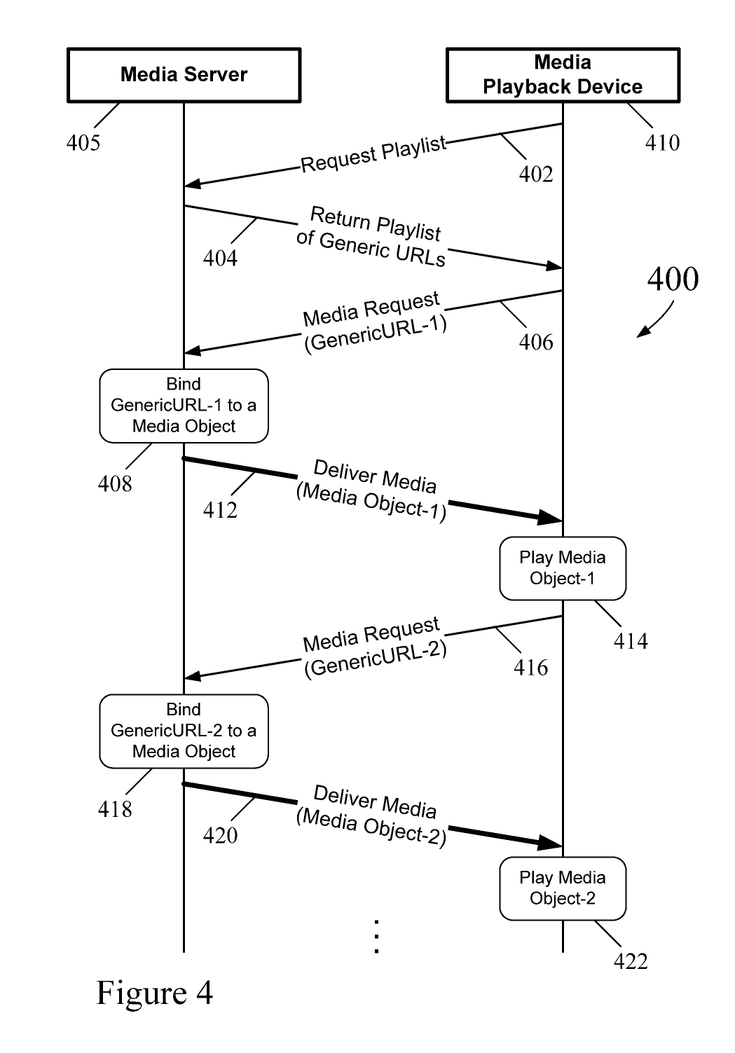

FIG. 4 generally illustrates a method 400 by which a media server 405 dynamically binds media objects to generic URLs in response to media requests from a media playback device 410. In step 402, the media playback device 410 requests a playlist from the media server 405. The media server 405 may have previously advertised the playlist to the media playback device 410 (e.g. on a web page, or via UPnP AV Content Directory Service, or a similar mechanism). In response to the request in step 402, the media server 405 returns a playlist of generic URLs to the media playback device 410 in step 404. In some embodiments, the playlist may be created before the media server receives the playlist request. For example, the playlist may be a file stored on the media server. In other embodiments, the media server may generate the playlist in response to the playlist request. For example, the media server may generate the playlist so that the generic URLs of the playlist identify the media playback device which sent the request, as previously noted.

The media playback device may process the playlist to extract the generic URLs, and may request media objects using these URLs. As illustrated in FIG. 4, in step 406 the media playback device 410 may send a first media request to the media server 405 wherein the first media request specifies GenericURL-1. The media server 405 may receive the first media request and may bind a first media object to GenericURL-1 as shown in step 408. As used herein, the first media object is referred to as “Media Object-1”. In step 412, the media server 405 may deliver Media Object-1 to the media playback device 410 in response to the first media request. The media playback device 410 may play Media Object-1 as shown in step 414. For example, the media playback device may render video content and/or audio content of Media Object-1 for a user of the media playback device. Media delivery and playback may utilize a streaming model, a download model, a progressive download model, or any other delivery and playback model as known to one skilled in the art.

In step 416, the media playback device 410 may send a second media request to the media server 405 wherein the second media request specifies GenericURL-2. The media playback device 410 may automatically send the second media request when the playback of Media Object-1 is completed or is within some threshold of completion. For example, the second media request may be sent when there are 10 seconds of Media Object-1 left to play, or when only the final 50 kbytes of Media Object-1 remain in the playback buffer. Alternately, the media playback device may send the second media request in response to user input. For example, the user of the media playback device 410 may invoke a user interface function to skip to the next object in the current playlist. Such a function may be a button on an infra-red remote control, a press-able button displayed on a touchscreen user interface, a click-able icon displayed on a PC monitor, or any other user input convention as known to one skilled in the art.

The media server 405 may receive the second media request and may bind a second media object to GenericURL-2 as shown in step 418. As used herein, the second media object is referred to as “Media Object-2”. In step 420, the media server 405 may deliver Media Object-2 to the media playback device 410 in response to the second media request. In step 422, the media playback device 410 may then proceed to play Media Object-2.

The media server 405 may require that the media playback device 410 issue media requests based on the generic URLs in the known order in which such URLs are present in the playlist. To this end, the user of the media playback device may be instructed to disable the shuffle mode of the media playback device 410. Additionally, the user may be instructed that the playlist should be played in a looped mode so that the media playback device 410 will loop back to the first generic URL after completing playback of the last generic URL in the playlist. The media server 405 may have a popup window, a help screen, associated documentation, and/or the like to instruct the user that the playlist should be played with shuffle mode OFF and with loop mode ON. Alternately, the media server 405 may insert metadata into the playlist itself wherein the metadata instructs the user that the playlist should be played with shuffle mode OFF and with loop mode ON.

If the media playback device 410 plays the playlist with shuffle mode ON, then the media server 405 may detect that the media requests are not presenting the generic URLs in continuous order. For example, the media server 405 may detect that a first media request specifies generic URL-1, a second media request specifies generic URL-7, and a third media request specifies generic URL-4. In this case, the media server 405 may conclude that the media playback device 410 is playing the playlist in shuffle mode, and the media server 405 may disable navigation features which rely on the generic URLs being presented in the standard order. For example, the media server 405 may be unable to determine forward motion or backward motion through the playlist, where such motion may be the result of a user navigating the playlist using the user interface of the media playback device 410. Such navigation features will be described for some of the illustrative embodiments presented below.

In an embodiment of the present invention, the system has a media server which offers a dynamic queue of media objects to be played by a media playback device using a playlist of generic URLs. The content of the dynamic queue may be modified by the media server after the playlist is delivered to the media playback device. Moreover, the content of the dynamic queue may be modified while the media playback device is simultaneously playing media objects from the queue using the playlist. Thus, the embodiment advantageously provides a system and method by which the media server may adapt the list of media objects referenced by a playlist after the playlist is delivered, despite the media server not having access to edit the delivered playlist. Further, the present invention provides a system and method by which the media server may adapt the list of media objects referenced by a playlist even while the playlist is being used by a media playback device to play back the referenced media. The media server may provide a dynamic media service to any media playback device which supports one or more standard, well-known playlist formats.

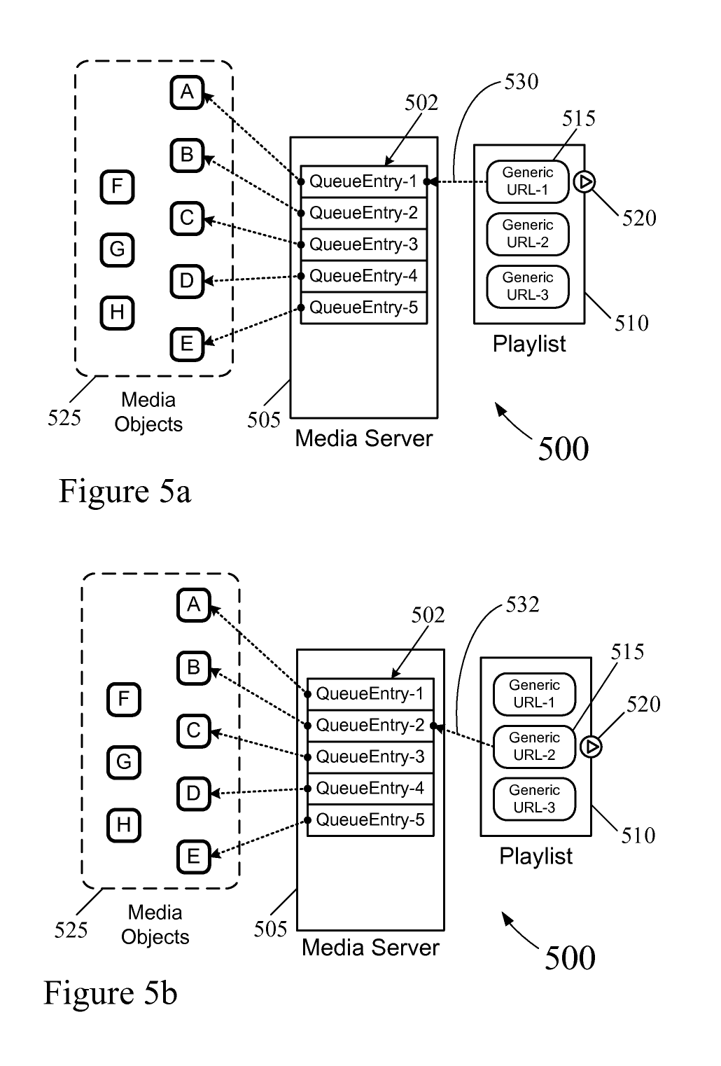

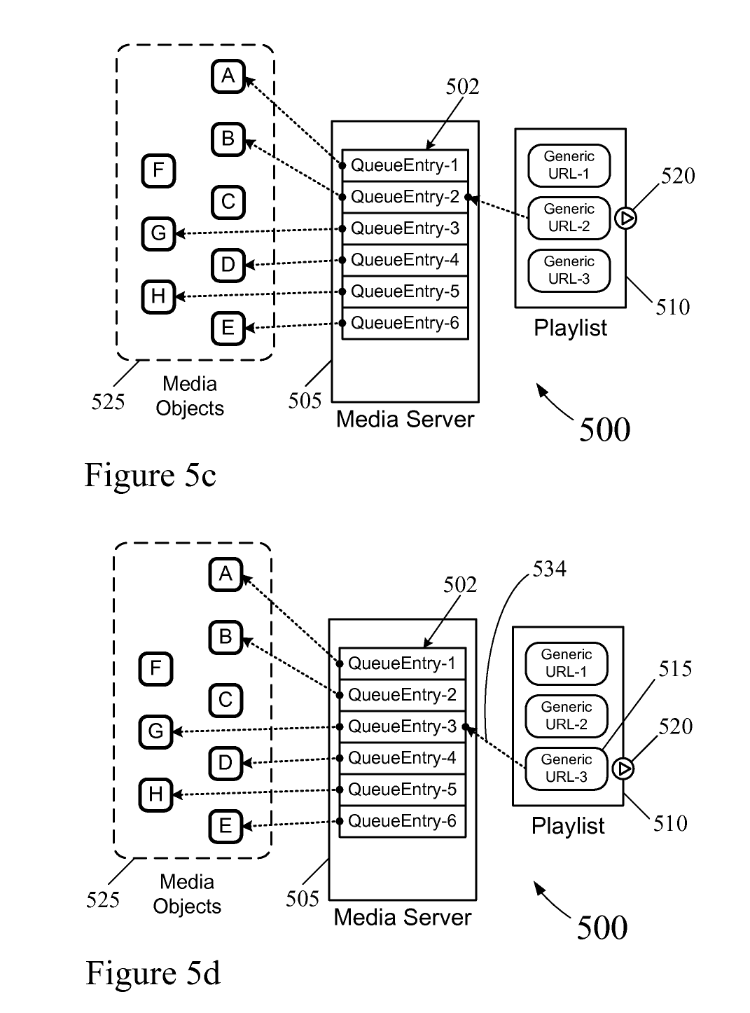

Referring specifically to the FIGs., FIGS. 5a-5e illustrate an embodiment of a system 500 of the present invention wherein a media server 505 offers a dynamic queue 502 of media objects. The media server 505 provides a playlist 510 of generic URLs to a media playback device, and the media playback device requests media objects from the media server 505 using the generic URLs 515. The playlist 510 is illustrated in FIGS. 5a-5e, and for the current example is shown having three generic URLs 515. The media playback device is not shown in FIGS. 5a-5e; however, a “play” position symbol ( [symbol] ) 520 is placed on the playlist 510 within each of FIGS. 5a-5e to indicate the current playback position of the media playback device. Specifically, the play position symbol 520 indicates the generic URL 515 which the media playback device is currently using to retrieve and play back media from the media server 505.

Each of FIGS. 5a-5e illustrates the state of the dynamic queue 502 as maintained internally by the media server 505. The dynamic queue 502 may have any number of entries, each of which refers to one of the media objects 525 accessible to the media server 505. Upon receiving an incoming media request from the media playback device, the media server 505 maps the request to an appropriate queue entry and begins delivery of the corresponding media object 525 in response to the request.

FIG. 5a illustrates the dynamic queue 502 provided by the media server 505 in an embodiment of the present invention. A media playback device (not shown, refer to 110 in FIG. 2) uses the playlist 510 of Generic URLs 515 to access Media-Object-A as referenced by QueueEntry-1. Specifically, FIG. 5a illustrates an initial state wherein the dynamic queue 502 has five entries QueueEntry-1, QueueEntry-2, QueueEntry-3, QueueEntry-4 and QueueEntry-5, which correspond to media objects A, B, C, D, and E, respectively. The media playback device receives and/or parses the playlist 510, and begins requesting media objects 525 using the generic URLs 515 to request media from the media server 505. Initially in step 530 the media playback device sends a media request which specifies generic URL-1, as this is the first URL entry in the playlist 510. As this is the first request received from the specific media playback device, the media server 505 maps the request to the first queue entry, QueueEntry-1. In response to the request, the media server 505 begins delivery of the corresponding media object (A) to the media playback device. In this way, the media playback device begins to receive and to play media object A.

The media playback device may complete playback of media object A, or the media playback device may reach some internal threshold where enough of media object A has been played that the media playback device is ready to request the next media object referenced by the playlist 510. Alternately, the user of the media playback device may request that the media playback device skip to the next media object referenced by the playlist. In either case, the media playback device may send a media request to the media server wherein the media request specifies generic URL-2.

FIG. 5b illustrates the dynamic queue 502 provided by the media server 505 in an embodiment of the present invention. The media playback device (not shown) uses the playlist 510 of Generic URLs 515 to access Media-Object-B as referenced by QueueEntry-2. As shown in step 532 in FIG. 5b, the media server 505 may receive the media request which specifies Generic URL-2. The media server 505 will recognize that Generic URL-2 is the second URL of the playlist 510, and that this URL is one position higher than the URL used in the previous request from the media playback device. Therefore, the media server 505 will map the media request to the next entry in the dynamic queue 502, namely QueueEntry-2. As the internal state of the dynamic queue 502 associates QueueEntry-2 to media object B, the media server 505 will begin delivery of media object B to the media playback device in response to the media request. In this way, the media playback device begins to receive and to play media object B.

In an embodiment of the present invention, the media server 505 of FIGS. 5a-5e may modify the dynamic queue 502. Such a modification may be based on internal server logic, for example the media server 505 may discover that new media objects appropriate to the dynamic queue 502 are available in the local network and as a result may add one or more of the new media objects 525 to the dynamic queue. Alternately, the modification may be based on instructions from a user, for example the media server 505 may have a user interface which allows a user to control and to modify the contents of the dynamic queue 502 in real time. As another option, the modification may be based on signals from an external source, for example the media server 505 may be monitoring lists of popular media objects from a media service or a social media networking site, and may modify the dynamic queue 502 in response to changes to these external lists. As yet another option, the modification may be based on the incoming media requests from the media playback device, for example the media server 505 may determine that the media playback device is skipping media objects without completely playing them, and in response the media server 505 may adapt the dynamic queue 502 to remove media objects which are similar to the media objects the media playback device is skipping, and/or to add media objects which are dissimilar to the skipped media objects. These are presented as examples which may be appropriate to certain embodiments; however, the modifications to the dynamic queue 502 may be triggered and/or controlled by other logic or events without departing from the central form and spirit of the invention.

FIG. 5c illustrates the dynamic queue 502 provided by the media server 505 in an embodiment of the present invention. The media server 505 modifies the queue while Media-Object-B is playing to the media playback device (not shown). FIG. 5c illustrates the internal state of the media server 505 after the media server 505 modifies the dynamic queue 502 by replacing media object C with a new media object G, and further inserting media object H in between the existing entries for media objects D and E. As a result, the dynamic queue 502 now has six Queue Entries which reference media objects A, B, G, D, H, and E respectively. In the current example embodiment, the modifications were carried out while the media playback device continues to play media object B based on the earlier media request specifying Generic URL-2.

The playlist 510 has not been modified in this procedure. The media playback device may be unaware that the underlying dynamic queue 502 has been modified by the media server 505, and in fact the media playback device and/or the user of the media playback device may not be aware of the upcoming queue entries (QueueEntry-3 through QueueEntry-6). The media playback device may be only aware that it has played media object A, and that the media playback device is currently playing media object B.

The media playback device may complete playback of media object B, may determine that enough of media object B has been played that the media playback device should request the next media object, may receive instructions from a user that the media playback device should skip to the next media object, and/or the like. As a result, the media playback device may send a media request to the media server wherein the media request specifies the next generic URL in the playlist, namely generic URL-3.

FIG. 5d illustrates the result. The media playback device (not shown) uses the playlist 510 of Generic URLs to access Media-Object-G as referenced by QueueEntry-3. As shown in step 534 of FIG. 5d, the media server 505 may receive the media request which specifies Generic URL-3, may recognize that Generic URL-3 is the third URL of the playlist, and may conclude that this URL is one position higher than the URL used in the previous request from the media playback device. As a result, the media server may map the incoming media request of step 534 to QueueEntry-3. In light of the recent modifications to the dynamic queue 502, the media server 505 may determine that QueueEntry-3 refers to media object G. Therefore, the media server 505 may begin delivering media object G to the media playback device in response to the media request of step 534, and the media playback device may begin playing media object G.

The media playback device may complete playback of media object G, may determine that enough of media object G has been played that the media playback device should request the next media object, may receive instructions from a user that the media playback device should skip to the next media object, and/or the like. As a result, the media playback device may send a new media request to the media server. As the media playback device has reached the end of the 3-entry playlist, the media playback device may loop back to the first entry in the playlist. As a result, the media playback device may send a media request to the media server wherein the media request specifies generic URL-1.

FIG. 5e illustrates the dynamic queue 502 provided by the media server 505 in an embodiment of the present invention. A media playback device (not shown) uses the playlist 510 of Generic URLs 515 to access Media-Object-D as referenced by QueueEntry-4. As illustrated in step 536 of FIG. 5e, the media server 505 may receive the media request which specifies Generic URL-1, may recognize that Generic URL-1 is the first URL of the playlist, and may conclude that the media playback device looped from the last playlist entry (Generic URL-3) as used in the previous media request, back to the first entry at the start of the playlist. As a result, the media server 505 may map the incoming media request to QueueEntry-4, one entry higher than the entry mapped to the previous request.

More generally, the media server 505 may consider a movement from the last playlist entry to the first playlist entry to represent motion forward to the next entry in the dynamic queue 502, and the media server 505 may consider a movement from the first playlist entry to the last playlist entry to represent a skip backward to the previous entry in the dynamic queue. Such jumps in the generic URL position may result from the media playback device playing and/or navigating the playlist in a “looped” mode. Furthermore, the jumps may be distinguishable and may be interpreted in the described manner, provided the playlist 510 contains at least three URLs.

Returning to the example embodiment as illustrated in FIG. 5e, the media server 505 may map the incoming media request of step 536 to QueueEntry-4, and may determine that QueueEntry-4 currently refers to media object D. Therefore, the media server 505 may begin delivering media object D to the media playback device in response to the media request of step 536, and the media playback device may begin playing media object D.

While not explicitly shown in FIG. 5e, one skilled in the art should understand that the media playback device may continue playing the playlist entries sequentially, and as a result the media playback device may subsequently issue media requests which specify Generic URL-2 and Generic URL-3, respectively. The media server 505 may map these subsequent media requests to QueueEntry-5 and QueueEntry-6, respectively. If no further modifications are made to the dynamic queue 502 in the meantime, then the state of the dynamic queue 502 will remain as illustrated in FIG. 5e, and the media server 505 may begin delivery of media objects H and E respectively, in response to these subsequent media requests.

Of course, the media server 505 may modify the dynamic queue 502 at any time. In this case, any subsequent media request would be mapped to a media object according to the state of the dynamic queue 502 at the time the subsequent media request was received by the media server 505.

Therefore, the embodiment of the present invention illustrated in FIGS. 5a-5e advantageously provides that the media playback device may send media requests to the media server using the generic URLs from the playlist, according to the normal playlist logic and/or user playlist navigation capabilities of the media playback device. Further, upon receiving a media request, the media server may identify the generic URL included in the request, and may determine the position of the generic URL within the playlist.

When the position of the generic URL is incremented between two subsequent requests, or when the position loops from the end of the playlist to the start of the playlist, the media server may interpret this as forward motion and may move to the next queue entry in the dynamic queue maintained internally in the media server. The media server may thus deliver the media object corresponding to the next entry in the dynamic queue.

When the position of the generic URL is decremented between two subsequent requests, or when the position loops from the start of the playlist to the end of the playlist, the media server may interpret this as backward motion and may move to the previous queue entry in the dynamic queue maintained internally in the media server. The media server may thus deliver the media object corresponding to the previous entry in the dynamic queue.

At any time in the embodiment of FIGS. 5a-5e, the media server may modify the dynamic queue maintained internally in the media server. For example, the media server may delete one or more queue entries, may add and/or insert one or more queue entries, may modify the order of existing queue entries, and/or the like. Such modifications may be performed while the media playback device is actively requesting, receiving, and/or playing media objects from the dynamic queue using the generic URLs from the playlist. The modifications will affect how the media server maps subsequently received media requests to media objects.

In most cases, modification to the dynamic queue entries as noted above will not affect the playback of the current media object by the media playback device. The media server will simply modify the queue entries which appear before and/or after the currently playing queue entry, and the modifications will be used to determine what media objects should be delivered in response to subsequent media requests.

One exception may occur when the media server deletes or modifies the queue entry which corresponds to the media object which is currently being received and/or played by the media playback device. In view of this exception, in an embodiment, the media server may disallow deletion or modification of the queue entry which corresponds to a currently playing media object. Doing so has the advantage of not interrupting the user's playback experience.

Alternatively in another embodiment, the media server may interrupt delivery of the currently playing media object in order to delete and/or modify the corresponding queue entry. For example, if the media object is being delivered using a TCP session, the media server may interrupt the delivery by signaling the end of the TCP session (sometimes known as “tearing down” the session). The media server may then delete and/or modify the corresponding queue entry. The media playback device may subsequently send a media request to the media server, and the media server may respond by delivering the media object corresponding to the next queue entry according to the modified state of the dynamic queue.

The ending and/or “tearing down” of the TCP delivery session is given as an example; however, there may be other methods of signaling the delivery interruption. The media server may interrupt the delivery of the current media object using any other signaling method as known to one skilled in the art.

While the above example illustrated a single media playback device, the media server may deliver media objects to multiple media playback devices simultaneously using essentially the same techniques. In this case, the media server may maintain different internal states for each of the media playback devices to which media objects are being delivered. When receiving a media request, the media server may identify the media playback device which sent the request, and as a result the media server may refer to the corresponding internal state when determining which media object should be delivered in response to the media request. Determination of the media playback device may be made based on information in the generic URL, or based on other information present in the media request, as previously described.

In an embodiment, the media server may maintain internal state records for a single dynamic queue which specifies the media objects for delivery to multiple media playback devices, wherein the media server maintains for each media playback device an internal state record which indicates the current queue entry and/or the current media object being delivered to and/or being played by the media playback device. In this way, the media server may have a dynamic queue which is shared among multiple media playback devices, where each of the media playback devices may request, retrieve, and/or play the referenced media objects at an individual pace determined by the media playback device.

In another embodiment, the media server may maintain internal state records for multiple dynamic queues wherein each queue specifies the media objects for delivery to a different media playback device. The media server may in this case maintain an internal state record which indicates the current queue entry and/or the current media object for each of the different media playback devices. In this way, the media server may create, generate, modify and/or maintain a personalized list of media objects for delivery to each media playback device.

In another embodiment of the present invention, an external control device is used to select media objects and/or to control playback of selected media objects on a media playback device which does not support control by the external control device, and/or which is incapable of receiving control commands from the external control device. The media playback device may retrieve a playlist of generic URLs from a media server, and the media playback device may systematically request media objects using the generic URLs. The external control device may communicate with the media server in order to select the media objects which the media server will deliver in response to media requests from the media playback device.

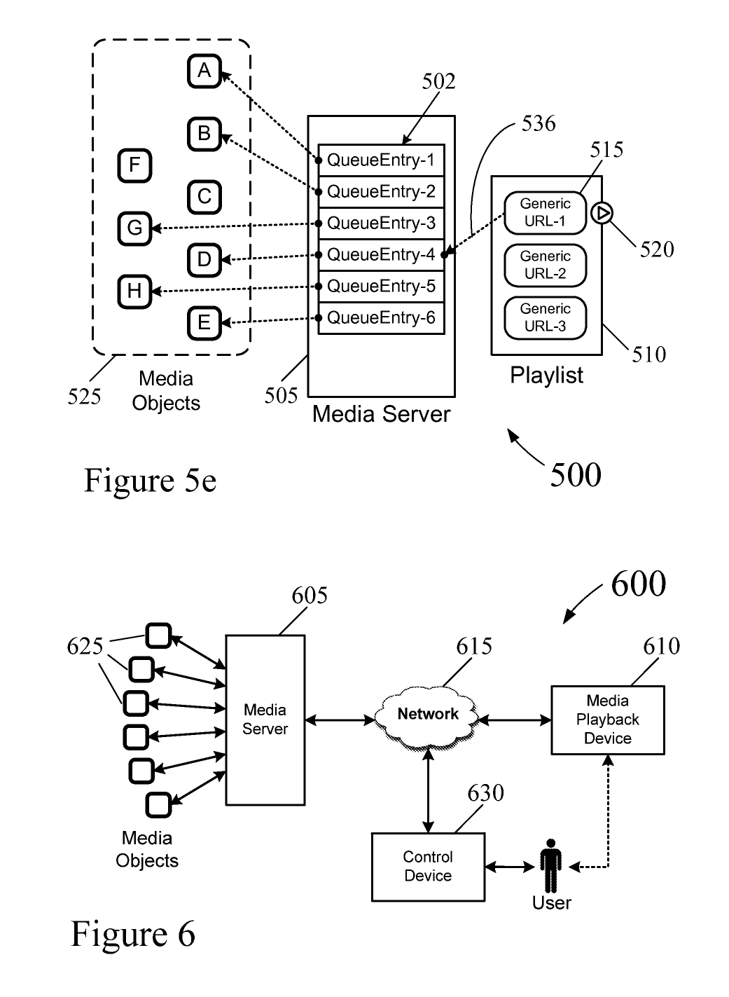

FIG. 6 illustrates a system 600 including a typical network configuration in which an embodiment of the present invention may be utilized. FIG. 6 is similar to FIG. 2 in that FIG. 6 has a media server 605 and a media playback device 610 which are connected to a network 615, wherein the media server 605 has access to media objects 625. FIG. 6 differs from FIG. 2 in that a control device 630 is also connected to the network 615. The control device 630 communicates with the media server 605 in order to discover, select, arrange, and/or organize media objects 625 for delivery to the media playback device 610. The control device 630 may be a mobile telephone, a smartphone, a tablet computing device, a laptop PC, a desktop PC, a gaming device, a dedicated network media remote control device, and/or the like.

As a first example of an embodiment of the present invention, the control device 630 may have a web browser and the media server 605 may provide web pages which are displayed in the web browser and which allow a user of the control device 630 to browse, search, and/or discover media content accessible to and/or available from the media server 605 and to select, arrange, and/or organize media objects 625 for delivery to the media playback device 610. By interacting with the web pages, the control device 630 may essentially create, populate, modify and/or control a dynamic queue within the media server 605, and the media playback device 610 may request, retrieve and play media objects from the dynamic queue in a manner similar to that previously described.

As a second example of an embodiment of the present invention, the control device 630 may be a standard UPnP AV control point and/or a standard DLNA control point and the media server 605 may act as a UPnP AV media server and/or a DLNA media server to advertise the media objects 625 accessible to and/or available from the media server 605. The media server 605 may additionally advertise itself as an UPnP AV Renderer which supports external control and/or a DLNA compliant rendering device which supports external control. In this way the media server 605 may accept standard requests from the control device 630 to render media objects 625 available from the media server 605. In response to such requests, the media server 605 may add the requested media objects 625 to a dynamic queue maintained internally by the media server 605. The media server 605 may then deliver the media objects 625 to the media playback device 610 in response to subsequent media requests from the media playback device 610, wherein the media requests specify the generic URLs from a playlist delivered to the media playback device 610. In this way, the media server 605 may allow a standard UPnP AV Control Point and/or a standard DLNA control point to select media objects 625 for delivery to a media playback device 610 which does not support external control, and which is systematically requesting media objects 625 using the generic URLs from a playlist of generic URLs.

As a third example of an embodiment of the present invention, the control device 630 may communicate with the media server 605 using a proprietary protocol for browsing, searching, and/or discovering media content accessible to and/or available from the media server 605 and for selecting, arranging, and/or organizing media objects 625 for delivery to the media playback device 610. The proprietary protocol may allow the control device 630 to create, populate, modify and/or control a dynamic queue within the media server 605, and the media playback device 610 may then request, retrieve and play media objects from the dynamic queue using the generic URLs. To this end, the control device 630 may have a proprietary software application which communicates with the media server 605 using the proprietary protocol, and which presents a user interface on the control device 630 to allow the user to browse, search, and/or discover media objects 625, to select media objects 625 for delivery to the media playback device 610, and/or to edit a dynamic queue of media objects 625 maintained by the media server 605.

While several examples have been disclosed, one skilled in the art will recognize other techniques by which a control device may communicate with a media server in order to browse for and/or search for media objects and to select media objects for delivery to a media playback device. An embodiment of the present invention may utilize any such techniques as known to one skilled in the art.

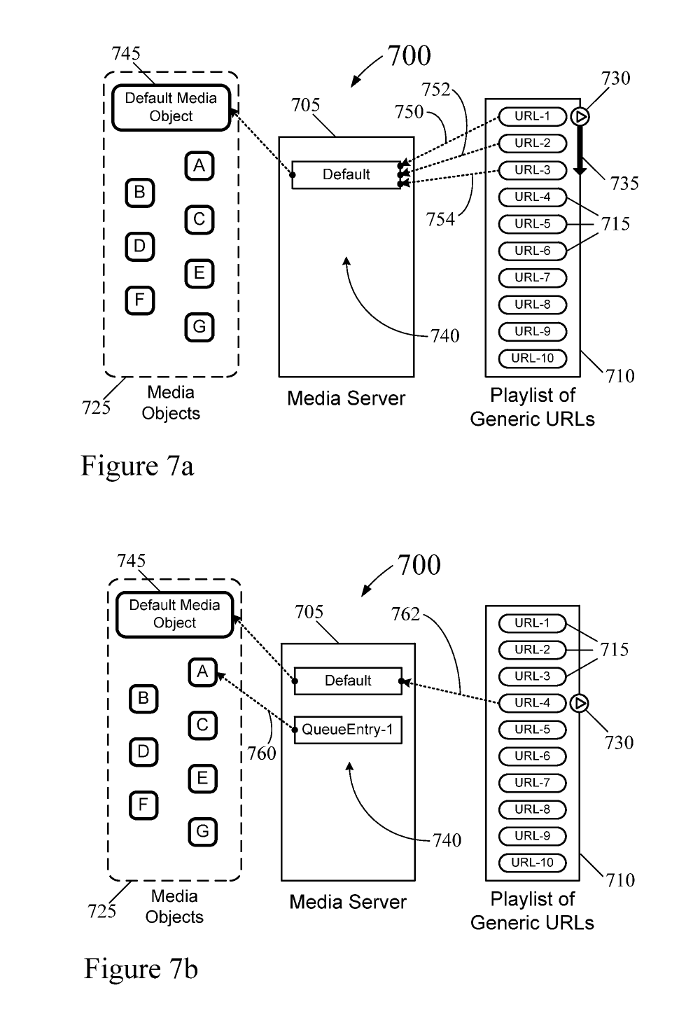

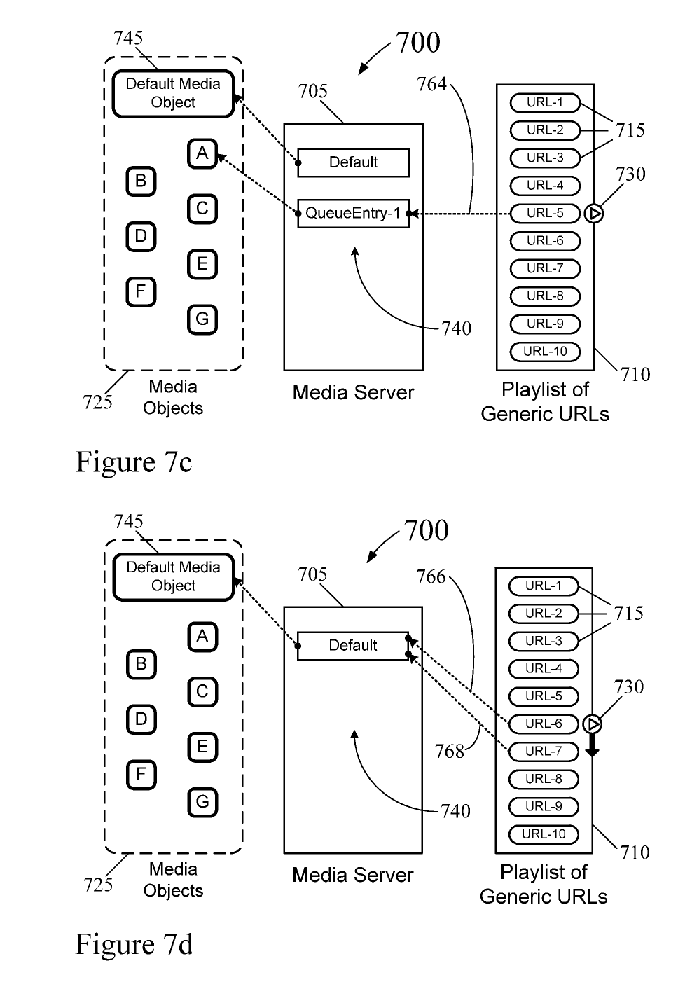

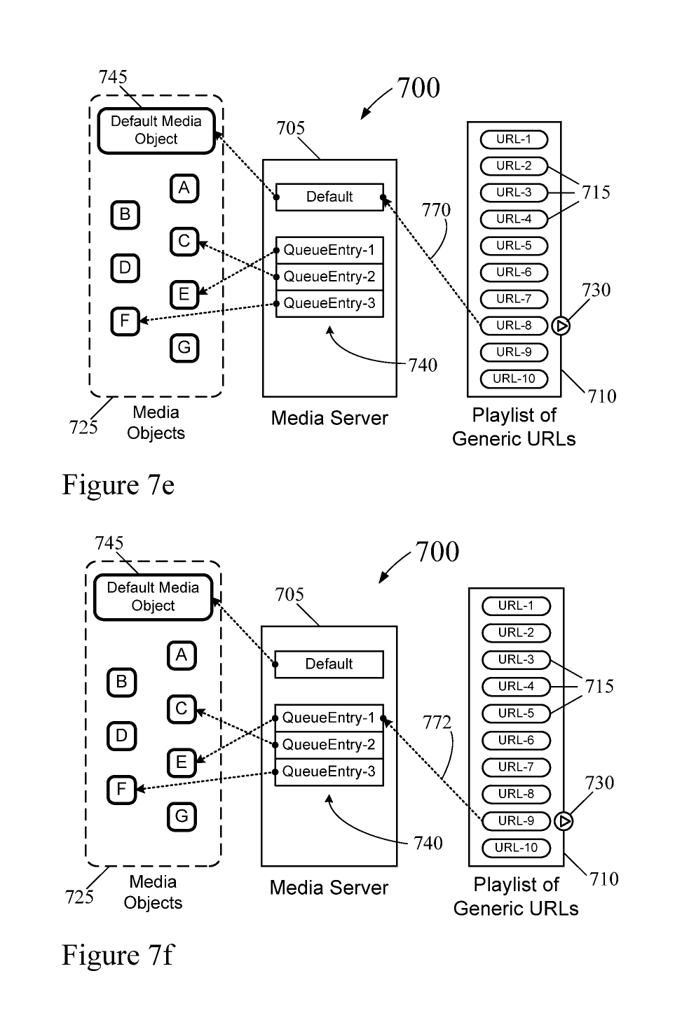

FIGS. 7a-7f illustrate an embodiment of a system 700 of the present invention wherein a control device (not shown in FIGS. 7a-7f, refer to reference numeral 630 of FIG. 6) communicates with a media server 705 to select media objects 725 for delivery to a media playback device (not shown in FIGS. 7a-7f, refer to reference numeral 610 of FIG. 6). The media server 705 provides a playlist 710 of generic URLs 715 to the media playback device, and the media playback device 610 requests media objects 725 from the media server 705 using the generic URLs 715. For the current example, the playlist 710 shows ten generic URLs 715; however, the number of generic URLs in the playlist 710 may vary by embodiment as noted previously. As in previous FIGs., a “play” position symbol ( [symbol] ) 730 is overlaid on the playlist 710 within each of FIGS. 7a-7f to indicate the current playback position of the media playback device 610. A downward arrow 735 is used to indicate the progress of the media playback device 610. Specifically, the arrow indicates that the media playback device 610 has sequentially placed media requests based on multiple generic URLs over a time period.

Each of FIGS. 7a-7f illustrates the state of a dynamic queue 740 as maintained internally by the media server 705. The dynamic queue 740 may have any number of entries, each of which refers to a media object 725 accessible to the media server 705. Upon receiving an incoming media request from the media playback device 610, the media server 705 maps the request to an appropriate queue entry and begins delivery of the corresponding media object 725 in response to the request. At times, the dynamic queue 740 may be empty (i.e. consisting of zero queue entries). In this case, the media server 705 may respond to an incoming media request by delivering a default media object 745 to the media playback device 610. The default media object 745 may be used during time periods where no media objects 725 have been selected by the control device 630 (shown in FIG. 6) for delivery to the media playback device 610. For example, the default media object 745 may be a video object consisting of five seconds of empty black or gray video frames, accompanied by silent audio. As another example, the default media object 745 may be an audio object consisting of ten seconds of silent audio. As a third example, the default media object 745 may consist of a blank black or gray photograph. The default media object 745 may visually depict a company logo.

The default media object 745 may convey advertising content. For example, the default media object 745 may convey a short audio advertisement, a short video advertisement, or a still image which presents an advertisement. In these cases, the media server 705 may have access to a pool of default media objects which convey different advertisements, and the media server 705 may deliver a different default media object 745 to the media playback device 610 each time the media server 705 receives a media request when the dynamic queue 740 is empty. The pool of default media objects which convey advertisements may be stored locally by the media server 705, or they may be accessible to the media server 705 from a remote location. For example, they may be available from an “ad server” which is a separate server than the media server 705.

In yet another embodiment, the media server 705 may mix “blank” default media objects with default media objects which convey advertising. For example, the media server 705 may deliver blank default media objects for a certain time period after the dynamic queue 740 becomes empty, and may switch to advertising content after the dynamic queue 740 has been empty for some predefined time period, such as 30 seconds or two minutes.

FIG. 7a illustrates an embodiment of the present invention in an initial state wherein the media server 705 has access to the default media object 745 and multiple additional media objects 725. The additional media objects 725 are depicted in FIG. 7a as media objects A, B, C, D, E, F, and G. As previously noted, a small number of media objects 725 is shown in the FIGs. to illustrate the invention, where in practice a media server 705 may have access to any number of media objects 725 which may be stored locally or remotely with respect to the media server 705.

The control device 630 (not shown in FIGS. 7a-7f) may communicate with the media server 705 to create, modify, and/or control the dynamic queue 740 of media objects 725 for presentation to the media playback device 610. As shown in FIG. 7a, the dynamic queue 740 may be initially empty, a state reflecting the fact that the control device 630 has not yet selected any media objects 725 for delivery to the media playback device 610. The media playback device 610 may receive the playlist 710 of generic URLs 715, and may proceed to issue media requests based on the generic URLs 715. For example, a user may select the playlist 710 from the user interface of the media playback device 610, and may instruct the media playback device 610 to begin playing the playlist 710. The user may arrange appropriate playback settings for the media playback device 610, for example the user may instruct the media playback device 610 to play the playlist 710 in a looped fashion and with shuffle mode turned off. As a result, the media playback device 610 may proceed to issue media requests based on the generic URLs 715 in the order depicted in the playlist 710, and may loop back to the first generic URL after using the last generic URL in the playlist 710.

As shown in FIG. 7a, the media playback device (not shown in FIGS. 7a-7f) may request media objects 725 using Generic URLs 715 from the playlist 710 of Generic URLs 715. As shown in step 750, the media playback device 610 may issue an initial media request using generic URL-1. The media server 705 may receive the initial media request, and may determine that the dynamic queue is empty. As a result, the media server 705 may deliver the default media object 745 to the media playback device 610 in response to the request. The media playback device 610 may receive and play the default media object 745, which as noted previously may contain blank and/or silent media, or which may contain advertising.

Upon completion of playback of the default media object 745, the media playback device 610 may send a second media request using generic URL-2 as shown in step 752. The media server 705 may determine that the media playback device 610 has moved to the second generic URL in the playlist 710. However, as the dynamic queue 740 is still empty, the media server 705 may deliver the default media object 745 in response to the second media request. Such a pattern may continue with the media playback device 610 requesting media objects 725 using the generic URLs 715 in sequence as shown in step 754. The media server 705 may repeatedly determine that the dynamic queue 740 is empty, and so may repeatedly deliver the default media object 745 in response to the requests. As a result, the media playback device 610 may play the default media object 745 multiple times, or may play multiple different default media objects, while the internal state of the media server 705 indicates an empty dynamic queue 740.

FIG. 7b illustrates the state of an embodiment of the dynamic queue 740 where a single media object (namely, Media-Object-A) has been added to the dynamic queue 740. The control device 630 (not shown in FIGS. 7a-7f) instructs the media server 705 to add Media-Object-A to the dynamic queue 740 for playback to the media playback device 610. The control device 630 communicates with the media server 705 to browse, search, and/or discover media objects accessible by and/or available from the media server 705, and to select a media object for delivery to the media playback device 610. For example, the control device 630 may instruct the media server 705 to execute a search using keywords selected by a user of the control device 630. In response, the media server 705 may return to the control device a list of media objects which match the provided keywords. For each media object 725, the media server 705 may provide metadata which identifies and/or describes the media object to the human user, as well as an identifier for the media object. The control device 630 and/or the human user may select a media object from the search results, and the control device 630 may send a message to the media server 705 which indicates that the selected media object should be delivered to the media playback device 610. The message may identify the selected media object using the media object identifier provided by the media server 705.

In the current example, the control device 630 selects media object A, and as a result the media server creates a new entry in the dynamic queue (Queue Entry-1) which references media object A as shown in step 760. The browsing, searching, discovering and/or selecting of the media object by the control device 630 may occur while the media playback device 610 continues to repeat the steps of requesting, retrieving, and/or playing back the default media object 745 using the generic URLs 715 from the playlist 710. Therefore, FIG. 7b shows that the media playback device 610 is playing the default media object 745 based on a media request 762 using the fourth generic URL from the playlist 710 at the time the media server 705 adds the Queue Entry-1 to the dynamic queue 740.

FIG. 7c illustrates that the media playback device 610 may complete playback of the default media object 745 as requested using the fourth generic URL as shown by step 762, and may then issue a new media request using the fifth generic URL as shown in step 764. The media playback device 610 requests media using a Generic URL from a playlist of Generic URLs, and the media server returns Media-Object-A as referenced by QueueEntry-1. The media server 705 may receive the media request of step 764, and may determine that the dynamic queue 740 is not empty and in fact contains a queue entry which corresponds to a media object. As a result, the media server 705 may deliver Media Object A to the media playback device 610 in response to the media request of step 764, and the media playback device 610 may receive and play back media object A as shown by the “play” position symbol 730.

The media server 705, upon delivering Media Object A to the media playback device 610, may remove the corresponding queue entry from the internal state of the dynamic queue 740. In this way, media objects added to the dynamic queue 740 may be played a single time on the media playback device 610.

After completing playback of Media Object A, or after coming within a threshold of completing playback, the media playback device 610 may send a new media request based on the next generic URL in the playlist, namely generic URL-6 as shown in step 766. The media server 705 may receive the media request of step 766, may identify generic URL-6 in the request, and determine based on the identification of generic URL-6 that the media playback device 610 is requesting to receive the next media object in the dynamic queue 740. However, the media server 705 may determine from the internal state of the dynamic queue 740 that the queue is again empty. Therefore, the media server 705 may deliver the default media object 745 to the media playback device 610 in response to the request of step 766. These steps may be repeated multiple times, and so FIG. 7d illustrates the media requests based on the sixth generic URL (step 766) and seventh generic URLs (as shown by step 768) in the playlist 710. The media playback device 610 requests media using Generic URLs from a playlist of Generic URLs, and the media server 705 repeatedly returns the default media object 745.

FIG. 7e illustrates the state where multiple media objects 725 have been added to the dynamic queue 740. A control device 630 instructs the media server 705 to add multiple media objects 725 to the virtual dynamic queue 740 for playback to the media playback device 610. As before, the control device 630 may communicate with the media server 705 to discover media objects accessible by and/or available from the media server 705. The control device 630 may then request the media server to add multiple media objects 725 to the dynamic queue 740 for delivery to the media playback device 610. For example, the control device 630 may select multiple media object identifiers from a list of media objects provided by the media server 705, and the control device 630 may send a message to the media server 705 which includes the media object identifiers which correspond to the selected media objects. The message may indicate the order in which the selected objects should be delivered. In the current example, the control device 630 selects and the media server 705 adds queue entries for three media objects which are depicted in FIG. 7e as media objects E, C, and F respectively. More generally, the control device 630 may select any number of media objects, and may specify these media objects using any number of messages exchanged between the control device 630 and the media server 705.

The media objects may be added to the dynamic queue 740 while the media playback device 610 is requesting, receiving, and/or playing another media object. In the current example as illustrated in FIG. 7e, the media playback device 610 is retrieving and playing the default media object 745 using generic URL-B as shown in step 770.

More generally, additions or modifications to the dynamic queue 740 may be requested by the control device 630 and may be carried out by the media server 705 while the media playback device 610 is playing media objects from the dynamic queue 740. An interaction of this type was previously described in the example embodiment of FIGS. 5a-5e.

The media playback device 610 may complete playback of a current media object, or may come within some threshold of completing the playback. The media playback device 610 may then send a new media request to the media server 705 using the next generic URL in the playlist. For example, as illustrated in step 772 of FIG. 7f, the media playback device 610 may send a media request based on generic URL-9. The media playback device 610 (not shown) requests media using Generic URLs, and the media server 705 successively returns the media objects referenced by the virtual queue entries. The media server 705 may receive the media request of step 772, may identify generic URL-9 in the request, and may determine that the media playback device 610 is requesting the next available media object. The media server 705 may refer to the internal state of the dynamic queue 740, and may map the media request to Queue Entry-1 as shown in step 772. As a result, the media server 705 may deliver Media Object E to the media playback device 610 in response to the request of step 772.

If the control device 630 does not request further additions or modifications to the dynamic queue 740, then the media playback device 610 may issue subsequent media requests based on generic URL-10 and generic URL-1, and such requests may cause the media server 705 to deliver media objects C and F, respectively. After playing these media objects, the media playback device 610 may issue additional media requests based on other generic URLs 715 beginning with generic URL-2. The media server 705 may determine that all media objects previously added to the dynamic queue 740 have been delivered already, and that the dynamic queue 740 is empty as a result. As long as no additional media objects are added by the control device 630, the media server 705 may respond to the additional media requests by repeatedly delivering the default media object 745.

In summary, the embodiment disclosed and illustrated in FIGS. 7a-7f provides that the media playback device may send media requests to the media server using the generic URLs from the playlist, according to the normal playlist logic and/or user playlist navigation capabilities of the media playback device. Upon receiving a media request, the media server may identify the generic URL included in the request, and may determine the position of the generic URL within the playlist. The media server may use this information to determine whether the media playback device is requesting a new media object from the dynamic queue. The media server may check the internal state of the dynamic queue to determine a media object which should be delivered to the media playback device in response to the request. If the dynamic queue is empty, or does not contain any media objects not previously delivered to the media playback device, then the media server may respond by delivering a default media object.

The control device may communicate with the media server to browse, search, and/or discover media objects and to select media objects for delivery to the media playback device. The control device may request the media server to add media objects to the dynamic queue, to delete media objects from the queue, to re-order the media objects in the queue, and/or the like. The media server may modify the dynamic queue in accordance with requests received from the control device.

As in the embodiment of FIGS. 5a-5e, the media server may modify the dynamic queue while the media playback device is playing media objects using the generic URLs from the playlist. Additions or modifications to the dynamic queue will modify the internal queue state, and will thus determine which media objects the media server may deliver in response to a future media requests.

During periods where the dynamic queue is empty, the media playback device may continue to send media requests, and the media server may repeatedly deliver a default media object, or multiple different default media objects. As a result, the media playback device may play blank and/or silent media objects during periods of queue emptiness, or may display other content not specifically selected for playback by the control device. The other content may convey advertisements, for example the media server may have access to a pool of advertising content and may deliver media objects which convey the advertising content as default media objects.

Although not shown in FIGS. 7a-7f, the media server may have multiple dynamic queues and may have corresponding internal state records to describe the multiple queues. Each of the multiple dynamic queues may specify media content selected for delivery to a different media playback device. Likewise, the media server may communicate with multiple different control devices which may request additions or modifications to the one or multiple dynamic queues maintained by the media server.

In a further embodiment of the present invention, a media server transforms an incoming internet radio stream into distinct audio objects. The media server delivers the distinct audio objects to a media playback device in response to media requests from the media playback device. The media requests are based on generic URLs from a playlist of generic URLs. The media server extracts metadata from the incoming internet radio stream, and embeds the corresponding metadata into the distinct audio object to which the metadata corresponds. The media playback device sends media requests to the media server, and the media server delivers the distinct audio objects to the media playback device in response to the media requests. The media playback device receives each audio object, plays the audio content of, each audio object and simultaneously displays the metadata which corresponds to each audio object.

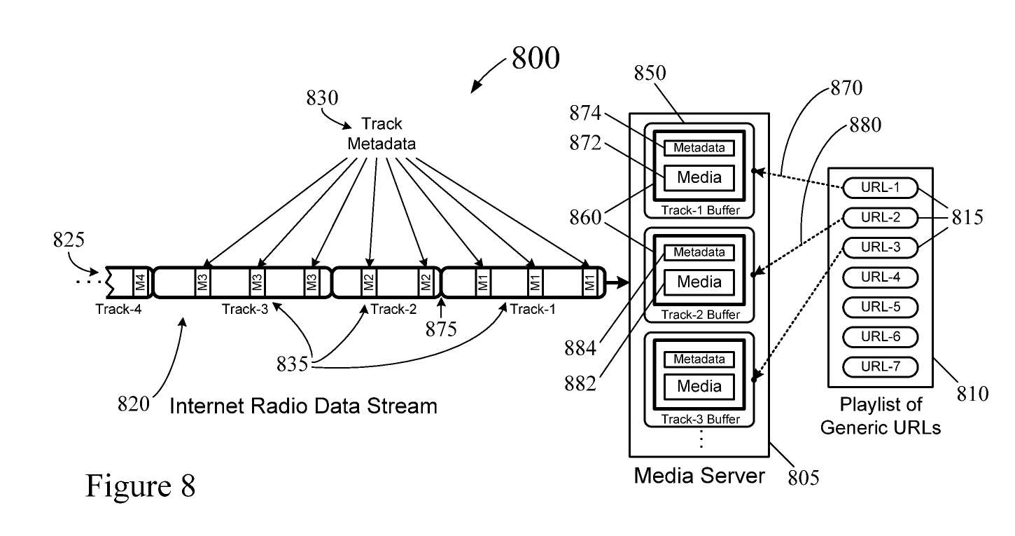

FIG. 8 illustrates a system 800 that has a media server 805 and a playlist 810 of generic URLs 815 which is processing an incoming internet radio data stream 820 in an embodiment of the present invention. The internet radio stream 820 may be a continuous stream of digital audio content 825 which has associated metadata 830 interleaved into the stream 820. As shown in FIG. 8, the metadata 830 may be interleaved at periodic intervals in terms of time or in terms of bytes. For example, a particular internet radio stream 820 may interleave metadata 830 into the digital audio content 825 every 10 seconds, every 20 seconds, every 8192 bytes, every 16000 bytes, every 32768 bytes, and/or the like. The internet radio stream 820 may signal the metadata interleave period to allow a recipient of the Internet radio stream to locate the metadata 830 within the stream 820. Alternately, the internet radio stream 820 may interleave metadata 830 in non-periodic fashion, and may signal the presence of each metadata package present within the stream 820.

The Internet radio stream 820 may be delivered via HTTP, TCP, UDP, or any other suitable network delivery protocol as known to one skilled in the art. The internet radio stream 820 may be a Shoutcast stream, an ICECast stream, an Ultravox stream, a RealAudio stream, and/or the like. The internet radio stream 820 may be any continuous stream of digital audio content with interleaved metadata as known to one skilled in the art.

As shown in FIG. 8, the Internet radio stream 820 may sequentially convey multiple audio tracks 835. For example, each audio track 835 may convey a different song or a different sound recording. For each of the multiple audio tracks 835, the internet radio stream 820 may contain digital audio content 825 with interleaved metadata 830. The digital audio content 825 may be a compressed audio format such as MP3, AAC, AACPlus, Ogg Vorbis, FLAC, Windows Media Audio, RealAudio, and/or the like. The metadata 830 may describe properties of the audio track 835 to which it corresponds. For example, the metadata 830 may convey a song title, an album title, an artist name, a music label, a recording date, a copyright date, a musical genre, and/or the like. The metadata 830 may describe properties of the internet radio stream 820. For example, the metadata 830 may convey the name of a radio station, the geographical location of the radio station, a musical style or theme of the radio station, the digital audio encoding format for the stream, and/or the like. The metadata 830 may have one or multiple fields to convey different properties of the audio track 835 and/or of the overall internet radio stream 820.

The media server 805 may analyze the incoming Internet radio stream 820 to detect and to extract the interleaved metadata 830. The media server 805 may further analyze the incoming internet radio stream 820 to determine transition points between the individual audio tracks 835. The internet radio stream 820 may contain markers which indicate the transition points between audio tracks 835, in which case the media server 805 may detect the markers. Alternately, the media server 805 may monitor properties of the digital audio content 825 to determine the transition points. For example, the media server 805 may monitor the volume, the frequency composition, the beat structure, the tempo, or other properties of the digital audio content 825 in order to detect a transition point from one audio track to another. In an embodiment, the media server 805 may detect audio fades and/or cross-fades in order to determine the transition points.

The media server 805 may monitor the metadata 830 to determine the transition points. Specifically, the media server 805 may detect changes or differences in the metadata 830 to determine the transition points. For example, the media server 805 may receive a first metadata structure in the incoming internet radio stream 820, and may compare the metadata to a second metadata structure which was previously received. If the first metadata structure conveys a different song title than the second metadata structure, then the media server 805 may determine that the location of the first metadata structure is a transition point.

The media server 805 may combine the above techniques in order to determine the transition points. For example, the media server 805 may detect differences in metadata 830 to approximately locate a transition point, and then may analyze the properties of the digital audio content 825 in the vicinity of the metadata difference in order to more precisely determine the transition point. The media server 805 may use any technique for determining the transition between two audio tracks 835 as known to one skilled in the art.

The media server 805 may create individual audio objects 860 each of which contain the digital audio content 825 and interleaved metadata 830 for a single music track. As illustrated in FIG. 8, the media server 805 may create, maintain, and/or fill an internal buffer 850 for each individual audio object 860. The media server 805 may create the buffer 850 for an individual audio object when the first bytes of that audio object are received from the internet radio stream 820, and may maintain the buffer 850 for a time period at least as long as the individual audio object 860 is relevant for delivery of the buffered data to one or more media playback devices 610 (not shown in FIG. 8). In this way, the media server 805 may be simultaneously extracting audio data content 825 and metadata 830 from the incoming internet radio stream 820, building the individual audio object 860 in the internal buffer 850, and delivering the already completed parts of the individual audio object 860 to one or more media playback devices 610. The individual audio object 860 may be a compressed audio file or a compressed audio stream in a well-known format which is compatible with the media playback device.

For example, the individual audio object 860 may be an MP3 file which encodes the audio data 825 for an audio track using MP3 frames and which conveys the metadata 830 for the audio track in an ID3 tag. As another example, the individual audio object 860 may be an MP4 file which encodes the audio data for an audio track using an AAC audio elementary stream and which conveys the metadata 830 for the audio track within an “udta” atom structure. These are given by way of example, and one skilled in the art will recognize other techniques for encoding audio data and associated metadata into individual audio objects which may be deliverable to and playable by a media playback device.

The media server 805 may provide the playlist 810 of generic URLs 815 to the media playback device 610. In FIG. 8, the playlist 810 is shown with seven generic URLs 815; however, as noted in the previous examples the playlist 810 may have any number of generic URLs 815. The media playback device 610 may receive the playlist 810, and may request audio objects 860 from the media server 805 using the generic URLs 815.

Upon receiving a first media request using generic URL-1 as shown in step 870 of FIG. 8, the media server 805 may begin delivering the individual audio object 860 for Track-1 to the media playback device 610. The media server 805 may be monitoring and buffering tracks from the internet radio stream 820 before receiving the request of step 870. In this case, the media server 805 may already have enough data buffered to begin immediately delivering the audio object 860 including Track-1 audio data 872 and associated metadata 874.

Alternately, the media server 805 may begin extracting and buffering Track-1 from the internet radio stream 820 in response to receiving the request of step 870 from the media playback device 610. In this case, the media server 805 may create, buffer and deliver an audio object based on Track-1 which does not contain the entirety of the Track-1 data, but rather which contains the portion of Track-1 audio data received by the media server 805 after the media server 805 receives the media request of step 870 from the media playback device 610. The media server 805 may delay responding to the media request of step 870 for a short time in order to buffer enough audio data to start the delivery of the audio object to the media playback device 610. During this initial buffering period, the media server 805 may determine whether the metadata for Track-1 874 is available from the received portion of the Internet radio stream 820. If the metadata for Track-1 874 is available, the media server 805 may include the metadata 874 in the audio object 860 for Track-1. If the media server 805 has not received the metadata for Track-1 874 after some initial buffering period, then the media server 805 may decide to begin delivery of the audio object 860 for Track-1 without the metadata 874. In this way, a user of the media playback device 610 may begin receiving the internet radio stream 820 in the middle of an audio track, without waiting for the start of the next audio track to be received by the media server 805.

As discussed above, the media server 805 may detect transition points between audio tracks 835 in the internet radio stream 820. For example, the media server 805 may detect a transition point 875 between audio Track-1 and audio Track-2, and may begin buffering the audio data 882 and metadata 884 associated with Track-2. The media server 805 may complete delivery of the audio object 860 for Track-1, and/or the media playback device 610 may complete playback of the audio object 860 for Track-1. As a result, the media playback device 610 may send a media request to the media server wherein the media request specifies generic URL-2 as shown in step 880 of FIG. 8. In response to the media request of step 880, the media server 805 may begin delivering the audio object 860 for Track-2 to the media playback device 610. The media playback device 610 may receive the audio object 860 for Track-2, and may display the metadata for Track-2 884 and play the audio data for Track-2 882.

These steps may be repeated for as long as the media server 805 continues to receive the internet radio stream 820, and for as long as the media playback device 610 continues to send media requests using the generic URLs 815 of the playlist 810. As in previous examples, the media playback device 610 may loop to the first generic URL of the playlist 810 after requesting media using the last generic URL of the playlist 810, and so the number of generic URLs 815 in the playlist 810 does not limit the number of tracks playable by the media playback device 610.

The media playback device 610 may have a user interface wherein the user of the media playback device may stop playback of the playlist via the user interface. As a result, the media playback device 610 may stop sending media requests based on the generic URLs, and/or the media playback device 610 may stop the current delivery session by tearing down the TCP session, or by executing a similar procedure for the protocol used to deliver the audio object.

As a result, the media playback device 610 may receive individual media objects which correspond to the audio tracks in the internet radio stream 820 which is received continuously by the media server 805. The media playback device 610 may thus play the media objects individually, and so may be capable of displaying metadata for each track in the Internet radio stream 820.

The above example is based on the audio content of an internet radio stream. However, one skilled in the art will recognize that a similar embodiment may be applied to transform a continuous video broadcast consisting of individual video programs, each with interleaved metadata, into a series of individual video objects for delivery to a media playback device. In this case the media server may create, maintain, and/or fill a buffer for each individual video object. Each individual video object may include encoded video data and metadata for a single video program extracted from the incoming broadcast. The media server may then deliver the individual video objects in response to media requests from a media playback device, wherein the media requests specify generic URLs from a playlist of generic URLs.

Various changes and modifications to the presently preferred embodiments described herein will be apparent to those skilled in the art. Such changes and modifications may be made without departing from the spirit and scope of the present invention and without diminishing its attendant advantages. Such changes and modifications are covered by the appended claims.

I claim:

1. A system for managing and delivering media in a network, the system comprising:
a media server connected to the network;
a media playback device connected to the network;
a plurality of media objects wherein the media server has access to the plurality of media objects;
a playlist having a plurality of generic URLs wherein each of the plurality of generic URLs does not refer to a specific media object and wherein each of the plurality of generic URLs specifies a position within the playlist wherein the media playback device transmits a first media request specifying a first generic URL from the playlist of generic URLs to the media server; and
a dynamic queue having a plurality of entries wherein the dynamic queue has a current state and wherein the current state of the dynamic queue is stored by the media server wherein the media server maps the first media request to the first entry of the plurality of entries in the dynamic queue and wherein the media server determines a first media object to deliver to the media playback device in response to the first media request wherein the first media object corresponds to the first entry in the dynamic queue mapped by the media server in response to the first media request and wherein the media server delivers the first media object to the media playback device via the network.

2. The system of claim 1 further comprising:
a control device connected to the network wherein the control device controls the current state of the dynamic queue and wherein the control device is a different device than the media server.

3. The system of claim 1 wherein the media playback device renders the first media object for a user and further wherein the media server modifies the dynamic queue while the media playback device is rendering the first media object.

4. A method for providing media objects from a media server to a media playback device wherein the media server is connected to a network and wherein the media playback device is connected to the network, the method comprising the steps of:
providing a plurality of media objects wherein the media server has access to the plurality of media objects;
providing a playlist comprising a plurality of generic URLs wherein each of the plurality of generic URLs does not refer to a specific media object and wherein each of the plurality of generic URLs specifies a position within the playlist;
transmitting a first media request specifying a first generic URL of the plurality of generic URLs to the media server wherein the media playback device transmits the first media request to the media server;
providing a dynamic queue comprising a plurality of entries wherein the dynamic queue has a current state and wherein the current state of the dynamic queue is stored by the media server;
mapping the first media request to a first entry of the plurality of entries in the dynamic queue wherein the media server maps the first media request to the first entry in the dynamic queue;
determining a first media object to deliver to the media playback device in response to the first media request wherein the first media object corresponds to the first entry in the dynamic queue mapped by the media server in response to the first media request; and
delivering the first media object to the media playback device wherein the media server delivers the first media object to the media playback device via the network.

5. The method of claim 4 further comprising the step of:
modifying the dynamic queue by adding a media object to the dynamic queue while simultaneously delivering a media object from the dynamic queue to the media playback device wherein the media server adds the media object to the dynamic queue.

6. The method of claim 4 further comprising the step of:
modifying the dynamic queue by deleting a media object from the dynamic queue while simultaneously delivering a media object from the dynamic queue to the media playback device wherein the media server deletes the media object from the dynamic queue.

7. The method of claim 4 further comprising the step of:
modifying the dynamic queue while simultaneously delivering the first media object from the dynamic queue to the media playback device wherein the media server modifies the dynamic queue based upon a list of media objects available from a remote website.

8. The method of claim 4 further comprising the steps of:
transmitting a second media request from the playlist of generic URLs to the media server wherein the media playback device transmits the second media request to the media server; and
modifying the dynamic queue in response to the receipt of the second media request, wherein the media server modifies the dynamic queue and wherein the timing of the second media request indicates that the previously delivered first media object was not completely played by the media playback device.

9. The method of claim 4 wherein the playlist has a list of n generic URLs used to request, retrieve and play media objects from a queue of m media objects, where n and m are integers and where n is not equal to m.

10. The method of claim 9 wherein the integer n is less than the integer m.

11. The method of claim 9 wherein the integer n is at least 3 and wherein the media server delivers media objects from the dynamic queue to the media playback device, the method further comprising the step of:
determining forward movement through the dynamic queue by comparing the position of a generic URL from one media request to the position of a generic URL from a subsequent media request and determining that the position has incremented between the two media requests wherein the media server compares the positions and determines that the subsequent position has incremented.

12. The method of claim 9 wherein the integer n is at least 3 and wherein the media server delivers media objects from the dynamic queue to the media playback device, the method further comprising the step of:
determining forward movement through the dynamic queue by detecting that the media playback device transmitting media requests looped from a last generic URL of the playlist back to the first generic URL of the playlist wherein the media server determines the movement.

13. A method for providing media from a media server to a media playback device in a network, the method comprising the steps of:
providing a plurality of media objects wherein the media server has access to the plurality of media objects;
providing a playlist comprising a plurality of generic URLs wherein each of the plurality of generic URLs does not refer to a specific media object and wherein each of the plurality of generic URLs has a position within the playlist;
transmitting a media request specifying a generic URL from the playlist of generic URLs to the media server wherein the media playback device transmits the media request to the media server;
determining the media object to deliver in response to the media request by mapping the generic URL specified in the media request to an entry in a dynamic queue stored in the media server wherein the media server maps the generic URL to the entry in the dynamic queue wherein the dynamic queue has a current state and wherein the current state of the dynamic queue is stored by the media server;
controlling the current state of the dynamic queue using a control device, wherein the control device is a different device than the media server; and
delivering the media object to the media playback device wherein the media server delivers the media object to the media playback device via the network.

14. The method of claim 13 further comprising the step of:
using the control device to cause the media server to modify the dynamic queue while the media server is simultaneously delivering the media object from the dynamic queue to the media playback device.

15. The method of claim 13 further comprising the step of:
using the control device to cause the media server to modify the dynamic queue by adding a media object to the dynamic queue while simultaneously delivering the media object from the dynamic queue to the media playback device.

16. The method of claim 13 further comprising the step of:
using the control device to cause the media server to modify the dynamic queue by re-ordering the media objects within the dynamic queue while simultaneously delivering the media object from the dynamic queue to the media playback device.

17. The method of claim 13 further comprising the step of:
delivering a default media object from the media server to the media playback device if the current state of the dynamic queue is empty when the media request is received by the media server.

18. The method of claim 17 wherein the default media object is a video object containing blank visual content and silent audio.

19. The method of claim 17 wherein the default media object is an audio object containing silent audio.

20. The method of claim 17 wherein the default media object displays a company logo.

21. The method of claim 17 wherein the default media object is a video advertisement.

22. The method of claim 17 wherein the default media object is an audio advertisement.

23. The method of claim 17 wherein the default media object is a mix of blank/silent default media objects and ad-bearing default media objects.

24. The method of claim 13 further comprising the step of:
displaying a web page provided by the media server on the control device wherein a user of the control device controls the dynamic queue using the web page.

25. The method of claim 13 wherein the control device is an UPnP AV control point.

26. The method of claim 25 further comprising the steps of:
providing the media server with an UPnP media renderer component;
browsing the media server with the UPnP AV control point to discover media objects using UPnP AV protocols; and
adding media objects to the dynamic queue by instructing the UPnP media renderer component of the media server to render media objects discovered using the UPnP AV protocols.

27. The method of claim 13 further comprising the step of:
selecting media objects for addition to the dynamic queue wherein the control device selects the media objects while the media playback device is playing other media objects from the dynamic queue wherein the media playback device requests delivery of the selected media objects using a playlist of generic URLs and further wherein the media playback device does not support external control by the control device.

28. The method of claim 13 further comprising the step of:
selecting media objects for addition to the dynamic queue wherein the control device selects the media objects while the media playback device is playing other media objects from the dynamic queue wherein the media playback device requests delivery of the selected media objects using a playlist of generic URLs and further wherein the media playback device is not capable of receiving a command from the control device which selects the media objects.

29. A method for transforming a continuous stream of media into individual media objects using a media server, the method comprising the steps of:
accessing a continuous stream of encoded media with interleaved metadata;
transforming the continuous stream of encoded media with interleaved metadata into a plurality of individual media objects using the media server;
providing a playlist comprising a plurality of generic URLs wherein each of the plurality of generic URLs does not refer to a specific media object and wherein each of the plurality of generic URLs has a position within the playlist;
using the generic URLs to enable a media playback device to request, retrieve and play the individual media objects;
delivering the individual media objects to the media playback device for playback; and
displaying the metadata for each of the individual media objects on the media playback device.

30. The method of claim 29 further comprising the steps of:
transmitting a first media request which specifies a first generic URL in the playlist of the plurality of generic URLs;
extracting the individual media objects from the continuous media stream, wherein the media server extracts the individual media objects in response to receiving the first media request which specifies the first generic URL in the playlist of the plurality of generic URLs; and
buffering the individual media objects from the continuous media stream, wherein the media server buffers the individual media objects in response to receiving the first media request which specifies the first generic URL in the playlist of the plurality of generic URLs.

32. The method of claim 29 further comprising the steps of:
detecting differences in the metadata in the continuous stream of encoded media; and
determining transition points between media objects in the continuous stream of encoded media wherein the media server determines the transition points based on the detected differences in the metadata.

33. The method of claim 29 further comprising the steps of:
detecting differences in the audio properties of the continuous stream of encoded media; and
determining transition points between media objects in the continuous stream of encoded media wherein the media server determines the transition points based on the detected differences in the audio properties.

34. A system for delivering media in a network, the system comprising:
a media server connected to the network;
a playlist having a plurality of generic URLs generated by the media server wherein the media server generates each generic URL to encode a specification of a position of each generic URL within the playlist; and
a media playback device capable of playing a playlist connected to the media server via the network wherein the media server delivers the playlist of generic URLs to the media playback device.

35. The system of claim 34 wherein the media server encodes an identifier into each generic URL and further wherein the media server maintains a record which maps the identifiers to the position of the generic URL within the playlist.

36. The system of claim 34 further comprising:
a first media request specifying a first generic URL of the plurality of generic URLs wherein the media playback device transmits the first media request to the media server wherein the media server selects a media object for delivery to the media playback device in response to the first media request and further wherein the selection of the media object is a function of the time at which the first media request is received by the media server.

37. A method for using a playlist with a media server and a media playback device to manage media objects in a network wherein the media server and the media playback device are connected to the network, the method comprising the steps of:
providing a playlist having a plurality of generic URLs wherein each of the plurality of generic URLs does not refer to a specific media object and wherein each of the plurality of generic URLs has a position within the playlist;
transmitting a first media request specifying a first generic URL to the media server wherein the media playback device transmits the first media request;
determining the position of the first generic URL in a playlist of generic URLs wherein the media server determines the position; and
using the determined position to select a first media object for delivery to the media playback device in response to the first media request wherein the media server selects the media object for delivery.

38. The method of claim 37 further comprising the steps of:
transmitting a second media request specifying a second generic URL to the media server wherein the media playback device transmits the second media request subsequent to transmitting the first media request; and
selecting a second media object for delivery to the media playback device based on a difference between the position of the second generic URL specified in the second media request and the position of the first generic URL specified in the first media request wherein the media server selects the second media object for delivery.

39. The method of claim 37 further comprising the steps of:
transmitting a second media request specifying the first generic URL to the media server wherein the media playback device transmits the second media request subsequent to transmitting the first media request; and
selecting a second media object for delivery to the media playback device wherein the media server selects the second media object for delivery and wherein the first, media object and the second media object do not encode the same media content.

40. The method of claim 37 further comprising the steps of:
encoding an identifier into each generic URL wherein the media server encodes the identifier into each generic URL; and
maintaining a record that maps the identifier to the position of the generic URL within the playlist and further wherein the media server maintains the record.
